(19) United States
(12) Patent Application Publication
(10) Pub. No.: US 2014/0310151 A1
(43) Pub. Date: Oct. 16, 2014

(54) MANAGEMENT OF A LINE OF CREDIT OR FINANCE-RELATED OFFER

(71) Applicant: RAWLLIN INTERNATIONAL INC., Tortola (VG)

(72) Inventors: Rodion Shishkov, St. Petersburg (RU); Simon Shvarts, San Jose, CA (US); Dmitry Bocharov, St. Petersburg (RU)

(73) Assignee: Rawllin International Inc., Tortola (VG)

(21) Appl. No.: 13/862,909

(22) Filed: Apr. 15, 2013

(51) Int. Cl. G06Q 40/00

(52) U.S. Cl. CPC G06Q 40/025
USPC 705/38

(57) ABSTRACT

Techniques for providing automated real-time approved financial offers to communication devices associated with users are presented. An open credit exchange platform (OCEP) includes a credit management component that collects personal and financial information respectively associated with users. Financial service providers associated with the OCEP generate approved financial offers, based on the personal and financial information, and assessment criteria of the financial service provider, and provide these financial offers to the OCEP. The OCEP evaluates the financial offers directed to a user and identifies at least a preferred financial offer for presentation to the communication device of the user. If the user decides to accept the financial offer, the user can enter the user's electronic signature on a contract relating to the financial offer via the communication device, and the electronic signature can verify the user's electronic signature, to facilitate creating a legally binding contract.

### TECHNICAL FIELD

This disclosure relates generally to financial-related management, and, more specifically, to managing a line of credit or a finance-related offer in a communication network environment.

### BACKGROUND

Today, users (e.g., consumers) can use communication devices (e.g., computers, mobile phones, electronic tablets, etc.) to access many different types of information, including financial information, perform financial transactions, and/or perform a variety of other functions. For example, users can access their bank accounts or credit accounts online, can make payments to financial accounts or transfer money between financial accounts online, or can access or receive offers (e.g., product or service sale offers) for products or services via online sites, emails, or text messages, etc.

When making purchases of products or services, consumers often can rely on credit (e.g., monetary loans, credit line on a credit card or other financial account, etc.) in addition to or as an alternative to using money. Conventionally, in many instances, when desiring credit for use in purchasing a product (e.g., car, house, appliance, home-related product, etc.) or service (e.g., obtaining a line of credit or monetary loan, heating and air conditioning service, roofing service, etc.), a consumer can fill out a loan or credit application that can include the consumer's personal information (e.g., name, address, phone number, etc.), employment history, financial or credit history, a credit check authorization, and/or other information. The potential creditor can review the information provided by the consumer and/or can access the person's financial or credit history through a third-party service (e.g., a financial or credit history aggregator service, which also can provide a standardized credit score that can be indicative of the credit worthiness of the consumer). Based at least in part on the review of the information provided by the consumer and/or the person's financial or credit history obtained via a third-party service, the potential creditor can make a determination regarding whether to offer the desired credit to the consumer for the purchase of the product. If the potential creditor determines that the consumer is sufficiently creditworthy, the potential creditor may make an offer to extend credit to the consumer in relation to the purchase of the product.

### SUMMARY

The following presents a simplified summary of various aspects of the disclosed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed subject matter in a simplified form as a prelude to the more detailed description that is presented later.

The disclosed subject matter can include a system that can comprise a memory to store computer-executable components; and a processor, coupled to the memory, that executes or facilitates execution of at least one of the computer-executable components, the computer-executable components. The computer-executable components comprising an open credit exchange component that is associated with a set of financial service provider identities and a set of consumer identities, and facilitates presentation of a preferred approved financial offer to a communication device determined to be associated with a consumer identity of the set of consumer identities. The computer-executable components also comprising a credit management component that determines the preferred approved financial offer, based on at least in part on an analysis of a set of approved financial offers received from one or more financial service provider identities of the set of financial service provider identities and a defined financial offer criterion with respect to a pre-computed financial health score associated with the consumer identity, to facilitate the presentation of the preferred approved financial offer to the communication device associated with the consumer identity.

The disclosed subject matter also can include a method comprising analyzing, by a system comprising a processor, a set of approved financial offers received from one or more financial service provider identities in relation to a consumer identity. The method also can comprise determining, by the system, a highest-rated approved financial offer from the set of approved financial offers, based at least in part on results of the analyzing of the set of approved financial offers and a financial offer criterion defined as a function of a real-time financial health score associated with the consumer identity, to facilitate presenting the highest-rated approved financial offer to a communication device associated with the consumer identity.

The disclosed subject matter further can comprise computer-readable storage medium storing computer-executable instructions that, in response to execution, cause a system comprising a processor to perform operations, comprising: evaluating a set of approved financial offers received from one or more devices associated with a set of financial service provider identities in relation to a consumer identity; and determining a preferred approved financial offer from the set of approved financial offers, based at least in part on results of the evaluating of the set of approved financial offers and a financial offer criterion defined with respect to a current financial health score pre-associated with the consumer identity, for presentation to a communication device associated with the consumer identity, wherein the preferred approved financial offer has a highest financial offer score relative to financial offer scores of other approved financial offers in the set of approved financial offers, and the current financial health score is a financial health score that is updated by the system in an always-on operating environment.

The following description and the annexed drawings set forth in detail certain illustrative aspects of the disclosed subject matter. These aspects are indicative, however, of but a few of the various ways in which the principles of the disclosed subject matter may be employed. The disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example system that can facilitate generating or selecting financial offers (e.g., a preferred approved financial offer(s)) and providing financial offers to communication devices associated with users (e.g., consumers), in accordance with various aspects and embodiments described herein.

FIG. 2 depicts a block diagram of an example credit management component, in accordance with various aspects and embodiments of the disclosed subject matter.

FIG. 3 illustrates a block diagram of an example financial service provider (FSP) credit management component, in accordance with various aspects and embodiments of the disclosed subject matter.

FIG. 4 illustrates a block diagram of an example consumer finances management component in accordance with various aspects and embodiments of the disclosed subject matter.

FIG. 5 depicts a diagram of an example system that can facilitate processing of financial offers (e.g., approved financial offers) and providing financial offers to communication devices associated with users (e.g., consumers), in accordance with various aspects and embodiments described herein.

FIG. 6 illustrates a flow diagram of an example method that can facilitate generating or selecting a financial offer (e.g., a preferred approved financial offer) and providing the financial offer to a communication device associated with a user (e.g., consumer), in accordance with various aspects and embodiments.

FIG. 7 depicts a flow diagram of an example method that can facilitate generating or selecting a financial offer (e.g., a preferred approved financial offer) and providing the financial offer to a communication device associated with a user (e.g., consumer), in accordance with various aspects and embodiments.

FIG. 8 presents a flow diagram of an example method for determining a financial health of a consumer, in accordance with various aspects and embodiments.

FIG. 9 is a flow diagram of an example method for generating a set of financial-related instructions that can facilitate improving the financial health of a consumer, in accordance with various aspects and embodiments.

FIG. 10 is a flow diagram of an example method for generating a mapping to facilitate mapping approved financial offers to consumers, in accordance with various aspects and embodiments.

FIG. 11 presents a flow diagram of an example method for determining an approved financial offer that can be presented to a consumer, in accordance with various aspects and embodiments.

FIG. 12 depicts a flow diagram of an example method that can facilitate accepting an approved financial offer and signing an electronic contract document associated with the approved financial offer via a communication device associated with a consumer in accordance with various aspects and embodiments.

FIG. 13 is a diagram of an example wireless communication device in accordance with various aspects and embodiments of the disclosed subject matter.

FIG. 14 is a schematic block diagram illustrating a suitable operating environment.

FIG. 15 is a schematic block diagram of a sample-computing environment.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Today, consumers can use communication devices to access many different types of information, including financial information, perform financial transactions, and/or perform a variety of other functions. When making purchases of products or services, consumers often can rely on credit (e.g., monetary loans, credit line on a credit card or other financial account, etc.) in addition to or as an alternative to using money.

Conventionally, in many instances, when desiring credit for use in purchasing a product (e.g., car, house, appliance, home-related product, etc.) or service (e.g., obtaining a line of credit or monetary loan, heating and air conditioning service, roofing service, etc.), a consumer can fill out a loan or credit application that can include the consumer's personal information (e.g., name, address, phone number, etc.), employment history, financial or credit history, a credit check authorization, and/or other information. The potential creditor can review the information provided by the consumer and/or can access the person's financial or credit history through a third-party service (e.g., a financial or credit history aggregator service, which also can provide a standardized credit score that can be indicative of the credit worthiness of the consumer). Based at least in part on the review of the information provided by the consumer and/or the person's financial or credit history obtained via a third-party service, the potential creditor can make a determination regarding whether to offer the desired credit to the consumer for the purchase of the product. If the potential creditor determines that the consumer is sufficiently creditworthy, the potential creditor may make an offer to extend credit to the consumer in relation to the purchase of the product.

Conventional processes for obtaining credit can be inefficient. For example, conventional processes for obtaining credit can be unnecessarily time consuming, as consumers may have to fill out a credit application and submit the application for approval before potentially receiving an approved financial offer or learning that they have not been approved for credit. Conventional processes for obtaining credit also can reduce the use of credit from a financial services provider by creditworthy consumers, as creditworthy consumers may not realize some credit opportunities available to them or may use other available financial resources (e.g., money from bank account, credit card from another financial services provider, etc.) to facilitate making purchases of products or services instead of using the financial services provider. Another deficiency can be that conventional processes for obtaining credit may reduce the purchase of products and services by creditworthy consumers, as creditworthy consumers may not realize some credit opportunities available to them to facilitate making purchases of products or services and, as a result, may not purchase such products or services thereby resulting in a reduction in product or service purchases.

To that end, techniques for providing automated real-time approved financial offers (e.g., a preferred approved financial offer(s)) to communication devices associated with users are presented. An open credit exchange platform (also referred to as, e.g., an open credit exchange component) can include a credit management component that can monitor and collect personal information, financial information, and/or consumer behavior information respectively associated with users (e.g., consumers), and/or other relevant information. The personal information, financial information, and/or consumer behavior information can include, for example, credit history of consumers (e.g., as reported by financial service providers associated with the open credit exchange platform, as reported by third-party credit reporting services, etc.), personal information (e.g., name, address, marital status, number of children, etc.) of consumers, employment history of consumers, consumer transaction history of consumers, assets and/or liabilities of consumers, social profile information associated with consumers (e.g., as provided to the open credit exchange platform by consumers, as obtained from a third-party social networking site, etc.), demographic information associated with consumers, etc. The credit management component can continue (e.g., continuously in real or near real time, periodically, dynamically, etc.) to monitor, collect, and/or update the personal information, financial information, consumer behavior information, and/or other relevant information.

The credit management component can analyze and/or classify the personal information, financial information, consumer behavior information, and/or other relevant information to facilitate providing analysis or classification results based at least in part on such information to financial service providers associated with the open credit exchange platform. In some implementations, the credit management component can provide raw data of the collected personal information, financial information, consumer behavior information, and/or other relevant information to financial service providers associated with the open credit exchange platform. The credit management component also can standardize data relating to the collected personal information, financial information, consumer behavior information, and/or other relevant information to facilitate presenting such information to the financial service providers. For example, the credit management component can process the collected personal information, financial information, consumer behavior information, and/or other relevant information to standardize or normalize such information to correspond to a defined N financial-related parameters associated with consumers to facilitate evaluation of the financial-related information by the financial service providers, and/or can generate respective financial health scores associated with respective consumers, as more fully disclosed herein. As part of the analysis or classification of such information, the credit management component also can verify respective pieces of information, assign accuracy confidence levels to respective pieces of information (e.g., rate the accuracy of a piece of information on a scale ranging from 0% to 100%), or otherwise provide an indication of the strength of the accuracy of respective pieces of data to facilitate enabling the financial service providers to understand the accuracy and reliability of the respective pieces of information and analyze the respective pieces of information accordingly.

The open credit exchange platform also can be an always-on, always-updating platform. For instance, the credit management component of the open credit exchange platform can continue to monitor (e.g, automatically or dynamically monitor (e.g., dynamically monitor in response to a detected financial event), monitor in real or near real time) information relating to consumers, such as a user (e.g., consumer). The credit management component can update or modify (e.g., automatically, dynamically, or in real or near real time) the respective financial health scores of respective consumers based at least in part on an evaluation of the monitored information and previous collected information, can store the updated or modified financial health scores of the respective consumers in respective user profiles of the users, and/or can make the updated or modified financial health scores of the respective users available to communication devices associated with the financial service providers and/or respective communication devices associated with the respective users.

Communication devices of financial service providers associated with (e.g., registered with, approved by, utilizing, etc.) the open credit exchange platform can access or receive information (e.g., personal information, financial information, consumer behavior information, and/or other relevant information; standardized or normalized information based at least in part on the personal information, financial information, consumer behavior information, and/or other relevant information; financial health scores of users; other financial-related information; etc.) from the open credit exchange platform. The communication devices of financial service providers can include or be associated with financial-service-provider (FSP) credit management components that can respectively analyze (e.g., in real or near real time) the information received from the open credit exchange platform (e.g., the credit management component of the open credit exchange platform) to facilitate respectively determining or identifying financial offers (e.g., approved credit offers) that the respective financial service providers desire to make to respective consumers associated with the received information.

An FSP credit management component of a financial service provider can generate approved (e.g., pre-approved, unconditionally approved) financial offers (e.g., instant lines of credit, instant loans, etc.) directed to respective users (e.g., consumers), based at least in part on the analysis of received information (e.g., personal information, financial information, consumer behavior information, and/or other relevant information; standardized or normalized information (e.g., N parameters) based at least in part on the personal information, financial information, consumer behavior information, and/or other relevant information; other financial-related information; etc.), and defined financial assessment criteria (e.g., defined financial risk criteria) of the financial service provider. In some implementations, the approved financial offers can be structured in a standardized form, in accordance with defined financial offer criteria (e.g., as specified by the credit management component of the open credit exchange platform), to facilitate providing standardized approved financial offers to consumers for an easy comparison by users (e.g., an “apples-to-apples” comparison rather than an “apples-to-oranges” comparison). The FSP credit management components of respective financial service providers can provide approved financial offers directed to respective users to the open credit exchange platform for further processing.

For each user, the credit management component of the open credit exchange platform can receive approved financial offers directed to the user (e.g., consumer) from one or more financial service providers associated with the open credit exchange platform, and can analyze or evaluate the approved financial offers. The credit management component can determine or identify one or more (e.g., the best the most preferred, or a subset of best or most preferred) approved financial offers of a set of approved financial offers directed to the user for presentation to the communication device or destination address associated with the user. The credit management component can transmit the one or more approved financial offers to the communication device of the user, for example, via a push notification operation (e.g., the credit management component automatically, dynamically, or periodically pushes approved financial offers to the communication device of the user) or a pull notification operation (e.g., the communication device automatically, dynamically, periodically, or in response to a request for the approved financial offers from the user of the communication device, requests approved financial offers from the credit management component).

The communication device (e.g., computer, mobile phone, electronic tablet, etc.) of the user can receive the one or more (e.g., the best or most preferred, or a subset of best or most preferred) approved financial offers from the credit management component. If the user decides to accept an approved financial offer, the user can use the user's communication device to enter the user's electronic signature on a contract (e.g., electronic contract document) relating to the approved financial offer. The open credit exchange platform can verify the user's electronic signature to facilitate creating a legally binding contract relating to the approved financial offer. The monetary funds or credit associated with the approved financial offer can be applied or deposited (e.g., automatically or instantaneously applied or deposited) to a financial account or financial transaction associated with the user. As a result, the user can be provided the financial benefit (e.g., monetary credit and associated financial conditions) associated with the approved financial offer (e.g., in relation to the purchase of a product or service), and the financial service provider can be provided the financial benefit (e.g., interest and fees relating to the extension of credit) per the legally binding contract. Further, it is not necessary for the user to prepare and submit a credit or loan application for consideration and approval by a financial service provider, since the financial offer presented to the user has already been approved by the financial service provider based at least in part on the information previously made available to the financial service provider by the open credit exchange platform and the defined financial assessment criteria of the financial service provider.

In accordance with various aspects, the open credit exchange platform can facilitate securing data, and protecting the privacy of users associated with the open credit exchange platform. In some implementations, the credit management component can expose information relating to consumers in an anonymous manner to financial service providers, so that the financial service providers are not able to identify a consumer, but rather are able to view financial-related information associated with the consumer. For example, the financial-related information can be associated with a consumer identification number or name (e.g., a pseudo number or name) to facilitate obscuring the consumer's actual name from the financial service providers. In certain implementations, the credit management component can enable a consumer, using the consumer's communication device, to control the information (e.g., control the type or amount of information) of the consumer that is exposed to (e.g., made available to) financial service providers associated with the open credit exchange platform. The credit management component and/or the consumer's communication device (e.g., via a financial application used by the communication device) can provide for transparency of the data by enabling the consumer to perceive and know which information of the consumer is being exposed to the financial service providers. The credit management component and the consumer's communication device (e.g., via the financial application) can employ an authentication protocol(s) or algorithm(s) to further facilitate securing data and financial transactions associated with the consumer in relation to the open credit exchange platform.

These aspects and other aspects of the disclosed subject matter are further described in relation to the drawings.

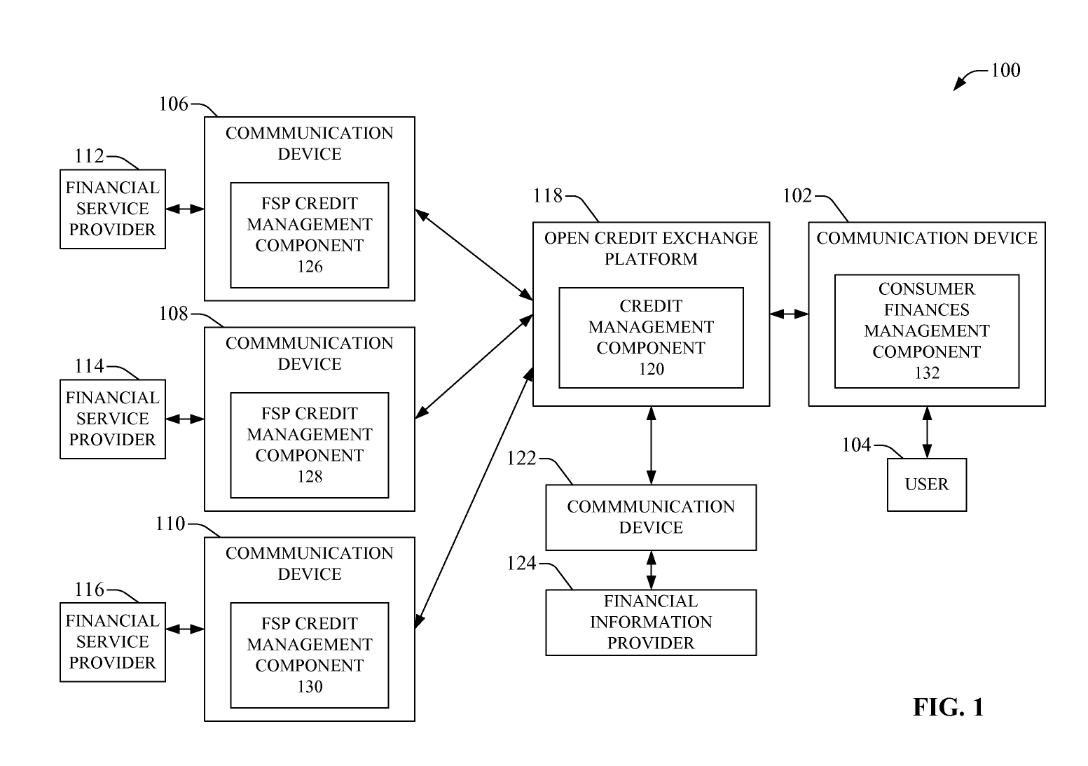

FIG. 1 illustrates a block diagram of an example system 100 that can facilitate generating or selecting financial offers (e.g., approved financial offers) and providing financial offers to communication devices associated with users (e.g., consumers), in accordance with various aspects and embodiments described herein. In an aspect, the system 100 can include a communication device 102 that can be associated with a user 104 (e.g., consumer). The communication device 102 can be, for example, a computer, a mobile or wireless communication device (e.g., a mobile phone and/or smart phone), an electronic tablet, pad, or notebook, an electronic gaming device, a set-top box, a personal digital assistant (PDA), etc.

The system 100 also can include a plurality of other communication devices, including communication device 106, communication device 108, and communication device 110, that can be respectively associated with a plurality of financial service providers, including financial service provider 112, financial service provider 114, and financial service provider 116. The financial service providers (e.g., 112, 114, 116) can be banks, lenders, stores, product or service providers that also provide financial services, peers (e.g., for peer-to-peer approved financial offers from one user (e.g., peer) to another user (e.g. peer)), or other entities. The financial service providers (e.g., 112, 114, 116) can be, for example, brick-and-mortar entities, or online or virtual entities. As part of their business, the financial service providers (e.g., 112, 114, 116) can lend money to users, maintain financial accounts (e.g., bank account, credit account, etc.) for users, extend credit (e.g., via a credit card account, credit line, etc.) to users, etc. In some instances, The financial service providers (e.g., 112, 114, 116) can provide the financial services (e.g., money loan, extension of credit, etc.) in relation to the purchase of products or services from the financial service provider or a third-party product or service provider.

The system 100 can comprise an open credit exchange platform 118 (also referred to herein as, e.g., an open credit exchange component) that can facilitate generating or selecting financial offers (e.g., approved financial offers) and providing financial offers to communication devices, such as communication device 102, associated with users (e.g., consumers), such as user 104, in accordance with defined financial offer criteria. At various times, the open credit exchange platform 118 can be associated with (e.g., communicatively connected to) communication device 102 to facilitate receiving information from the communication device 102 (e.g., information provided by the user 104 via the communication device 102), providing notifications of approved financial offers to the communication device 102, or providing other information to the communication device 102, etc. At various times, the open credit exchange platform 118 also can be associated with (e.g., communicatively connected to) communication device 106, communication device 108, and communication device 110 to facilitate providing information relating to consumers to the communication device 106, communication device 108, and communication device 110, receiving approved financial offers directed to users (e.g., 104) or other information from the communication device 106, communication device 108, and communication device 110, etc.

The open credit exchange platform 118 can comprise a credit management component 120 that can control operations associated with the open credit exchange platform 118, and can control providing information to financial service providers (e.g., 112, 114, 116) via respective communication devices (e.g., 106, 108, 110) to facilitate generation of approved financial offers by the financial service providers, processing of approved financial offers and other information received from the financial service providers or other entities, selecting of one or more (e.g., the best or most preferred, or a subset of best or most preferred) approved financial offers in relation to a user (e.g., 104), etc., as more fully disclosed herein.

In some implementations, the open credit exchange platform 118 can be associated with (e.g., communicatively connected to) a communication device 122 that can be associated with a financial information provider 124. The financial information provider 124 can be an entity in the business of collecting, analyzing, and processing financial data relating to consumers (e.g., user 104), and/or demographic information relating to consumers. For example, the financial information provider 124 can be a consumer reporting company that can generate and maintain credit reports, financial histories, and/or financial scores (e.g., credit scores), wherein the financial information provider 124 can provide such credit reports, financial histories, and/or financial scores to other entities (e.g., the open credit exchange platform 118, financial service provider 112, financial service provider 114, financial service provider 116, user 104, etc.), for example, when such other entities are authorized or entitled to obtain such information. A financial information provider 124 also can be a store (e.g., online store, brick-and-mortar store, etc.) or another user (e.g., another user who has engaged in a financial transaction associated with the user 104 or provides other financial-related information associated with the user 104). The credit management component 120 can use the financial information received from the financial information provider 124 via the communication device 122 to facilitate providing such financial information or information relating thereto (e.g., processed or synthesized information based on such financial information) to the financial service providers 112, 114, and 116 via communication devices 106, 108, and 110, or to the user 104 via communication device 102, or processing (e.g., analyzing, evaluating, etc.) such financial information to facilitate generating information for use in making financial offers, financial decisions, etc.

The credit management component 120 of the open credit exchange platform 118 can monitor and collect (e.g., automatically or dynamically collect, manually collect or receive, etc.) personal information, financial information, and/or consumer behavior information respectively associated with users 104 (e.g., consumers), and/or other relevant information. The personal information, financial information, and/or consumer behavior information can include, for example, credit history of users (e.g., as reported by financial service providers (e.g., 112, 114, 116) associated with the open credit exchange platform 118, as reported by third-party credit reporting services (e.g., financial information provider 124), etc.), personal information (e.g., name, address, marital status, number of children, etc.) of users (e.g., 104), employment history of users, consumer transaction history of user, assets and/or liabilities of users, social profile information associated with users (e.g., as provided to the open credit exchange platform by users, as obtained from a third-party social networking site, etc.), demographic information (e.g., age, sex, marital or family status, level of education, type of employment, professional affiliation or credentials (e.g., professional license(s) or registration(s)), geographic location, income bracket, cost of living in geographic region, political affiliation, etc.) associated with users, etc. The credit management component 120 can continue (e.g., continuously in real or near real time, periodically, dynamically, etc.) to monitor, collect, and/or update the personal information, financial information, consumer behavior information, and/or other relevant information to facilitate enabling the financial service providers (e.g., 112, 114, 116) to assess such information in real or near real time and generate approved financial offers to present to users (e.g., 104).

The credit management component 120 can analyze and/or classify the personal information, financial information, consumer behavior information, and/or other relevant information to facilitate providing analysis or classification results, based at least in part on such information, to the financial service providers (e.g., 112, 114, 116) associated with the open credit exchange platform 118 via the respective communication devices (e.g., 106, 108, 110). In some implementations, the credit management component 120 can provide raw data of the collected personal information, financial information, consumer behavior information, and/or other relevant information to financial service providers (e.g., 112, 114, 116) associated with the open credit exchange platform 118 via the respective communication devices (e.g., 106, 108, 110). The credit management component 120 also can standardize data relating to the collected personal information, financial information, consumer behavior information, and/or other relevant information to facilitate presenting such information to the financial service providers (e.g., 112, 114, 116) via the respective communication devices (e.g., 106, 108, 110). For example, the credit management component 120 can process the collected personal information, financial information, consumer behavior information, and/or other relevant information to standardize or normalize such information to correspond to a defined number (N) of financial-related parameters associated with consumers to facilitate evaluation of the financial-related information by the financial service providers (e.g., 112, 114, 116), wherein N can be virtually any desired integer number. As part of the analysis or classification of such information, the credit management component 120 also can verify respective pieces of information, assign accuracy confidence levels to respective pieces of information (e.g., rate the accuracy of a piece of information on a scale ranging from 0% to 100%), or otherwise provide an indication of the strength of the accuracy of respective pieces of data to facilitate enabling the financial service providers (e.g., 112, 114, 116) to understand the accuracy and reliability of the respective pieces of information and analyze or assess the respective pieces of information accordingly.

The credit management component 120 also can analyze the financial-related information (e.g., personal information, financial information, consumer behavior information, and/or other relevant information) associated with the respective consumers, and can determine respective financial health scores of respective consumers (e.g., including user 104) based at least in part on the analysis of the financial-related information and defined financial assessment criteria. The credit management component 120 can make the respective financial health scores, and/or other information (e.g., the defined N financial-related parameters, confidence levels or scores for respective parameters or information, etc.), available (e.g., allow access of the financial health scores or present the financial health scores of consumers) to financial service providers (e.g., 112, 114, 116) associated with the open credit exchange platform 118 to facilitate enabling financial service providers to assess the financial risk of making approved financial offers to respective consumers (e.g., user 104) in accordance with the respective defined financial assessment criteria of the respective financial service providers. The credit management component 120 also can provide the financial health score to a communication device 102 or destination address (e.g., mobile phone number, email address, address associated with a social networking site or social networking message box, etc.) associated with the consumer (e.g., user 104) to notify the consumer of the consumer's financial health score and/or as part of providing instruction to the consumer as to how the consumer can improve the consumer's financial health score, as more fully described herein. The credit management component 120 also can use the financial health scores of consumers to facilitate generating a mapping (e.g., real-time mapping) of approved financial offers from the financial service providers (e.g., 112, 114, 116) to the consumers (e.g., user 104), as more fully described herein.

The open credit exchange platform 118 also can be an always-on, always-updating platform (e.g., the system 100, including the open credit exchange platform 118 and credit management component 120, can be always-on and always-updating in real or near real time with regard to updating of financial health scores or other financial-related information associated with consumers, identifying or selecting a preferred approved financial offer(s) for a consumer, notifying consumers regarding the preferred approved financial offer(s), etc.). For instance, the credit management component 120 can continue to monitor (e.g, automatically or dynamically monitor (e.g., dynamically monitor in response to a detected financial event), monitor in real or near real time) information relating to consumers, such as user 104. The credit management component 120 can update or modify (e.g., automatically, dynamically, or in real or near real time) the respective financial health scores of respective consumers based at least in part on evaluation of the monitored information and previous information (e.g., financial-related information) relating to the consumers, can store the updated or modified financial health scores of the respective consumers in respective user profiles of the consumers, and/or can make the updated or modified financial health scores of the respective consumers available to communication devices (e.g., 106, 108, 110) associated with the financial service providers (e.g., 112, 114, 116) and/or respective communication devices (e.g., 102) associated with the respective consumers (e.g., user 104).

With further regard to the financial service providers (e.g., 112, 114, 116), the communication devices (e.g., 106, 108, 110) of the financial service providers (e.g., 112, 114, 116) associated with (e.g., registered with, approved by, utilizing, etc.) the open credit exchange platform 118 can access or receive information (e.g., financial-related information, such as personal information, financial information, consumer behavior information, financial health scores, and/or other relevant information (e.g., demographic information); standardized or normalized information (e.g., the defined N financial-related parameters) based at least in part on the personal information, financial information, consumer behavior information, financial health scores, and/or other relevant information; other financial-related information (e.g., confidence levels or scores associated with respective items or information or parameters); etc.) from the credit management component 120 of the open credit exchange platform 118. The communication devices (e.g., 106, 108, 110) of the financial service providers (e.g., 112, 114, 116) can include or be associated with financial-service-provider (FSP) credit management components, such as FSP credit management component 126, FSP credit management component 128, and FSP credit management component 130. The FSP credit management components (e.g., 126, 128, 130) can respectively analyze (e.g., in real or near real time) the information received from the credit management component 120 of the open credit exchange platform 118 to facilitate respectively determining or identifying financial offers (e.g., approved credit offers) that the respective financial service providers (e.g., 112, 114, 116) desire to make to respective consumers (e.g., user 104) associated with the received information, in accordance with respective defined financial assessment criteria (e.g., defined financial offer or risk criteria) associated with the financial service providers (e.g., 112, 114, 116).

An FSP credit management component (e.g., 126, 128, 130) of a financial service provider (e.g., 112, 114, 116) can determine and generate approved (e.g., pre-approved, unconditionally approved) financial offers directed to respective users (e.g., user 104), based at least in part on the analysis of received information (e.g., personal information, financial information, consumer behavior information, and/or other relevant information; standardized or normalized information based at least in part on the personal information, financial information, consumer behavior information, and/or other relevant information; other financial-related information; etc.), and the defined financial assessment criteria associated with the particular financial service provider (e.g., 112, 114, 116). In some implementations, an FSP credit management component (e.g., 126, 128, 130) can structure the approved financial offers in a standardized form, in accordance with defined financial offer criteria (e.g., as specified by the credit management component 120 of the open credit exchange platform 118), to facilitate providing standardized approved financial offers to consumers (e.g., user 104) for an easy comparison by users (e.g., essentially an “apples-to-apples” comparison rather than an “apples-to-oranges” comparison). The FSP credit management components (e.g., 126, 128, 130) of respective financial service providers (e.g., 112, 114, 116) can provide approved financial offers directed to respective users (e.g., user 104) to the open credit exchange platform 118 for further processing.

For each user, the credit management component 120 can receive or identify a set of approved financial offers directed to the user from one or more FSP credit management components (e.g., 126, 128, 130) of one or more respective financial service providers (e.g., 112, 114, 116) associated with the open credit exchange platform 118. The credit management component 120 can analyze or evaluate the approved financial offers in the set of approved financial offers to facilitate identifying or determining desirable approved financial offers, in accordance with the defined financial offer criteria. The credit management component 120 can identify or determine one or more desirable (e.g., the best or most preferred, or a subset of best or most preferred) approved financial offers from the set of approved financial offers directed to the user for presentation to the communication device 102 of the user 104.

For example, the credit management component 120 can determine or calculate a respective financial offer value (e.g., financial offer rating, financial offer score, etc.) for each approved financial offer in the set of approved financial offers based at least in part on the evaluation of the approved financial offers and in accordance with the defined financial offer criteria (and/or corresponding financial offer rules). The credit management component 120 can rank or order the approved financial offers in relation to each other based at least in part on their respective financial offer values (e.g., rank the approved financial offers from highest value to lowest value (or lowest value to highest value)). The credit management component 120 can identify the approved financial offer having the highest financial offer value as being the most desirable (e.g., best, most preferred, optimal, etc.) approved financial offer of the set of approved financial offers, and, as desired (e.g., when in accordance with the defined financial offer criteria), can identify an approved financial offer having the second highest financial offer value as being the second most desirable (e.g., second best or highest) approved financial offer of the set of approved financial offers, and so on. In some implementations (e.g., when in accordance with the defined financial offer criteria), the credit management component 120 can identify the preferred approved financial offer and/or one or more other approved financial offers in the set that meet or exceed a defined threshold (e.g., minimum threshold) financial offer value for selection and presentation to the consumer (e.g., user 104), and/or can select the preferred approved financial offer and/or one or more other approved financial offers in the set that meet or exceed the defined threshold financial offer value. The one or more desirable approved financial offers can be the preferred approved financial offer and/or the one or more other approved financial offers in the set that meet or exceed the defined threshold financial offer value.

The credit management component 120 can transmit the one or more desirable (e.g., most preferred or subset of most preferred) approved financial offers to the communication device 102 of the user 104, for example, via a push notification operation (e.g., the credit management component 120 can automatically, dynamically, or periodically push the approved financial offers to the communication device 102 of the user 104) or a pull notification operation (e.g., the communication device 102 can automatically, dynamically, periodically, or in response to a request for the approved financial offers from the user 104 of the communication device 102, request the approved financial offers from the credit management component 120). The notification of an approved financial offer can be in the form of, for example, a notification message associated with the financial application, a text message, an email message, or a voice mail message. A text message can be, for example, a short message service (SMS) message, an instant message (IM), a multimedia message (e.g., a multimedia messaging service (MMS) message), etc.

The communication device 102 (e.g., computer, mobile phone, electronic tablet, etc.) of the user 104 can receive the one or more desirable (e.g., the best or most preferred, or a subset of best or most preferred) approved financial offers, and/or notifications of such approved financial offers, from the credit management component 120. In some implementations, the communication device 102 can include (as depicted) or can access (e.g., via a web site) a consumer finances management component 132 that can be employed by the user 104 (e.g., consumer) to facilitate managing the finances of the user 104, accessing and/or using a digital wallet of the user 104, reviewing and/or accepting approved financial offers, executing financial transactions (e.g., making online or electronic payments for debts, goods, or services; accepting an approved financial offer and/or executing a contract; etc.), identifying a financial health or strength of the user 104, etc., as more fully described herein.

With regard to the one or more received approved financial offers, and/or notifications of such approved financial offers, the consumer finances management component 132 can process and present the one or more received approved financial offers and/or notifications of such approved financial offers to the user 104 via an interface(s) of the communication device 102. If the received information is a notification of an approved financial offer(s), the user 104 can use the consumer finances management component 132 to generate a message that can be sent to the open credit exchange platform 118 to facilitate obtaining further information regarding the approved financial offer(s) from the open credit exchange platform 118.

When the communication device 102 has the information relating to approved financial offer(s), the user 104 can review the approved financial offer(s) on the communication device 102. If the user 104 decides to accept an approved financial offer, the user 104 can use the user's communication device 102 to access a contract associated with the approved financial offer, and can enter the user's electronic signature on the contract relating to the approved financial offer. For example, the user 104 can select a control (e.g., button, icon, etc.) on a user interface on the communication device 102 to accept the approved financial offer, and the communication device 102 can present the contract to the user 104 for signature (e.g., electronic signature) via the user interface (e.g., the contract can be provided with the approved financial offer when the offer is initially sent or can be provided to the communication device 102 by the credit management component 120 for presentation to the user 104 in response to the user 104 accepting the approved financial offer). The consumer finances management component 132 can employ a defined security protocol(s) (e.g., authentication and/or cryptographic protocols) to facilitate secure execution (e.g., electronic signing) of the contract by the user 104, as more fully disclosed herein.

The consumer finances management component 132 can facilitate transmitting (e.g., via a secure communication channel) the signed (e.g., executed) contract to the open credit exchange platform 118. The credit management component 120 of the open credit exchange platform 120 can evaluate the signed contract and can verify the signature (e.g., electronic signature) of the user 104 to facilitate validating and creating a legally binding contract relating to the approved financial offer. In accordance with various implementations, the credit management component 120 can electronically sign (e.g., automatically) the contract on behalf of the financial service provider that made the approved financial offer, can provide the contract to the financial service provider for signature (e.g., automatic signature) by the financial service provider, or the approved financial offer can be executed by the financial service provider prior to presenting the approved financial offer to the open credit exchange platform 120 for presentation to the communication device 102 of the user 104.

In response to validating the legally binding contract relating to the approved financial offer, the credit management component 120 can apply or deposit (e.g., automatically or instantaneously applied or deposited) the monetary funds or credit associated with the approved financial offer (and contract) to a financial account or financial transaction associated with the user 104. In some implementations, the user 104 can be registered with the open credit exchange platform 118 and can have a financial account in which funds can be deposited or credit can be applied and/or, at the time of accepting the approved financial offer or signing the contract, the user 104 can use the communication device 104 to enter information identifying a financial account to which the user 104 desires the funds or credit to be deposited or applied. In other implementations, it is not necessary for the user 104 to be registered with the open credit exchange platform 118, and, at the time of accepting the approved financial offer or signing the contract, the user 104 can use the communication device 104 to enter information identifying a financial account to which the user 104 desires the funds or credit to be deposited or applied.

As a result, the user 104 can be provided the financial benefit (e.g., monetary funds or credit, and associated financial conditions) associated with the approved financial offer (e.g., in relation to the purchase of a product or service), and the financial service provider (e.g., 112) can be provided the financial benefit (e.g., interest and fees relating to the extension of credit) as provided in the legally binding contract. Further, it is not necessary for the user 104 to prepare and submit a credit or loan application for consideration and approval by a financial service provider (e.g., 112), since the financial offer presented to the user has already been approved by the financial service provider (e.g., 112) based at least in part on the information previously made available to the financial service provider (e.g., 112) by the open credit exchange platform 118 and the defined financial assessment criteria of the financial service provider (e.g., 112).

In accordance with various aspects, the credit management component 120 of the open credit exchange platform 118 can facilitate securing data, and protecting the privacy of users associated with the open credit exchange platform 118. In some implementations, the credit management component 120 can expose information relating to consumers in an anonymous manner to FSP credit management components (e.g., 126, 128, 130) of the respective financial service providers (e.g., 112, 114, 116) associated with the open credit exchange platform 118, so that the financial service providers (e.g., 112, 114, 116) are not able to identify a consumer (e.g., user 104) by the consumer's actual identity, but are able to view financial-related information associated with the consumer, wherein the financial-related information associated with the consumer can be associated with a unique pseudo name or number. For example, the credit management component 120 can associate (e.g., link, map, etc.) financial-related information with a consumer identification (ID) number or name (e.g., a pseudo number or name) to facilitate obscuring the consumer's actual name from the FSP credit management components (e.g., 126, 128, 130) and respectively associated financial service providers (e.g., 112, 114, 116), wherein the credit management component 120 can make the consumer ID number of name available to the FSP credit management components (e.g., 126, 128, 130) with the associated financial-related information of the consumer without allowing the FSP credit management components (e.g., 126, 128, 130) to obtain or identify the actual name of the consumer. In certain implementations, the credit management component 120 can enable a consumer (e.g., user 104), using the consumer's communication device 104, to control the information (e.g., control the type or amount of information) of the consumer that is exposed to (e.g., made available to) the FSP credit management components (e.g., 126, 128, 130) and respectively associated financial service providers (e.g., 112, 114, 116). The credit management component 120 and/or the consumer's communication device 102 (e.g., via the financial application used by the communication device 102) can provide for transparency of the data by enabling the consumer to perceive and know which information of the consumer is being exposed to the FSP credit management components (e.g., 126, 128, 130) and respectively associated financial service providers (e.g., 112, 114, 116). The credit management component 120 and the consumer's communication device 102 (e.g., via the financial application) can employ an authentication protocol(s) or algorithm(s) to further facilitate securing data and financial transactions associated with the consumer in relation to the open credit exchange platform 118.

With further regard to the consumer finances management component 132 of the communication device 102, the consumer finances management component 132 can be provided to or accessed by the communication device 102 using an application (e.g., financial application). For example, the communication device 102 can download the application and install the application on the communication device 102 to facilitate installing the consumer finances management component 132 on the communication device 102. Additionally and/or alternatively, the application can be a web-based application, wherein the communication device 102 can access the application and the consumer finances management component 132 via a web browser of the communication component 102.

The consumer finances management component 132 can facilitate providing (e.g., presenting), for example, a digital wallet that can enable the user 104 to view all or a desired portion of the financial accounts (e.g., bank account(s), credit or loan account(s), etc.), available approved financial offers, bills (e.g., billing statement for a payment due on a credit account), financial transaction history, financial health or strength, and/or other information (e.g., user preferences) associated with the user 104. The digital wallet can provide (e.g., present, display, etc.) the current purchasing power (e.g., including available purchasing power via an approved financial offer(s)) of the user 104 to the user 104, wherein, the current purchasing power can include current assets (e.g., liquid assets, such as money in a bank account), open lines of credit, available lines of credit through approved financial offers, etc. The consumer finances management component 132 (e.g., through use of the digital wallet) can facilitate enabling the user 104 to view and/or accept an approved financial offer, execute a contract (e.g., electronically sign an electronic contract document relating to an approved financial offer), make a payment on a financial transaction, bill, or account, transfer monetary funds between accounts of the user 104, registering or providing information relating to accounts of the user 104, create a user profile, select or modify user preferences, and/or perform other functions or transactions.

The consumer finances management component 132 also can facilitate setting preferences of the user 104 with regard to data security (e.g., security of information relating to the user 104 and/or secure control of data of the user 104 that is exposed) by the open credit exchange platform 118 and/or communication device 102, selection of approved financial offers by the open credit exchange platform 118, conditions under which the open credit exchange platform 118 is to refinance (e.g., automatically) an account(s) of the user 104 or notify the user 104 of an opportunity to refinance an account(s), notification of the user 104 in relation to financial health (e.g., in relation to a change in financial health or strength, in relation to instruction to facilitate improviding financial health or strength), and/or other functions associated with the consumer finances management component 132 or credit management component 120. The consumer finances management component 132 can store the user preferences in a user profile of the user 104, which can be stored in a data store, and can provide (e.g., transmit) the user profile and/or user preferences to the open credit exchange platform 118, wherein the credit management component 120 can store the user preferences (e.g., in the user profile generate by the communication device 102 or in a user profile generated by the credit management component 120). The credit management component 120 can implement the user preferences to facilitate identifying or selecting approved financial offers for the user 104, securing data associated with the user 104, identifying a financial health of the user 104, sending notifications to the user 104, etc.

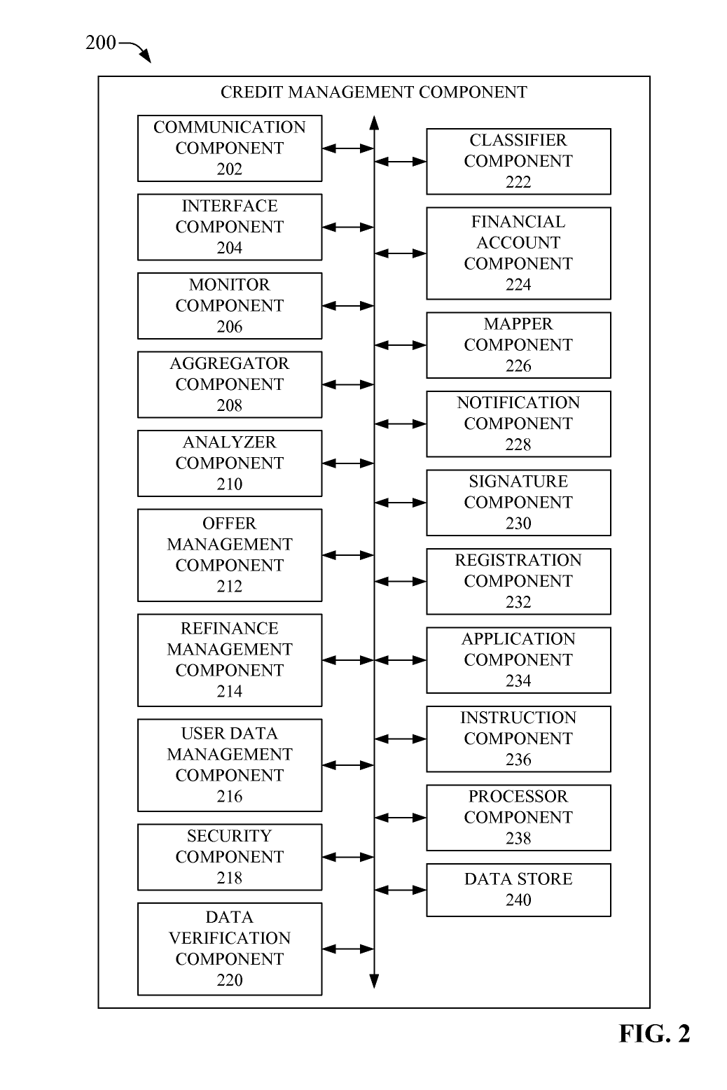

FIG. 2 depicts a block diagram of an example credit management component 200, in accordance with various aspects and embodiments of the disclosed subject matter. The credit management component 200 can be part of or associated with an open credit exchange platform, for example.

The credit management component 200 can comprise a communication component 202 that can communicate (e.g., transmit, receive) information, including financial-related information associated with users (e.g., consumers), information relating to approved financial offers, and/or other information, between the credit management component 200 and other components or devices, such as communication devices associated with users, financial service providers, and/or financial information providers. The communicator component 202 can employ one or more communication protocols to facilitate controlling data or voice flows, and/or wireless or wireline communication of traffic (e.g., voice or data traffic), associated with the credit management component 200.

The credit management component 200 can include an interface component 204 that can comprise one or more interfaces, including one or more controls, switches, adapters, connectors, buttons, routers, speakers, display screens, graphical user interfaces (GUIs), and/or touch screen GUIs, etc., that can facilitate enabling the credit management component 200 to interface and/or communicate with other systems, components, or devices (e.g., communication devices associated with consumers, financial service providers, or financial information providers; systems, components, or devices associated with a communication network(s); etc.), or users (e.g., administrators, engineers, technicians, etc.) associated with the open credit exchange platform. The interface component 204 can facilitate establishing a communication channel (e.g., a secure wireless or wireline communication channel) between the credit management component 200 and a communication device (e.g., of a consumer, financial service provider, financial information provider, etc.) associated with the open credit management platform.

The credit management component 200 can comprise a monitor component 206 that can monitor (e.g., continuously, periodically, dynamically (e.g., in response to a condition for monitoring information being met), etc.) information in real or near real time. The monitor component 206 can monitor, for example, financial-related information associated with respective consumers (e.g., as directly obtained by the credit management component 200, as obtained from financial service providers, as obtained from financial information providers, as provided by consumers, etc.), approved financial offers being provided by communication devices associated with financial service providers, outstanding debts associated with respective consumers, user preferences, etc.

The credit management component 200 also can contain an aggregator component 208 that can aggregate or collect the information (e.g., financial-related information, approved financial offers, user preferences, etc.). For instance, the aggregator component 208 can aggregate information received (e.g., obtained) from various entities (e.g., monitor component 206 or another component(s) of the credit management component 200, communication network, an application (e.g., a financial application, which can be a mobile or web application), a server or other communication device, processor, data store, etc.). The aggregator component 208 can correlate respective items of data based at least in part on type of data (e.g., information relating to a particular financial transaction, information relating to a particular financial offer, metadata, etc.), a consumer to which the data relates, source of the data, time or date the data was generated or received, etc., to facilitate analyzing or evaluating of the data by the analyzer component 210 or another component of the credit management component 200.

The analyzer component 210 can analyze, evaluate, and/or parse information (e.g., financial-related information, approved financial offers, user preferences, etc.) to facilitate identifying one or more desirable (e.g., a best or most preferred, or a subset of best or most preferred) approved financial offers, identifying or standardizing respective financial-related parameters or factors (e.g., N financial-related parameters or factors), synthesizing various pieces of information (e.g., financial-related information or other information associated with a consumer) to generate a financial-related parameter(s) or factor(s), adjusting a user profile relating to a user (e.g., consumer, financial service provider, etc.), verifying an electronic signature of a consumer, determining whether to refinance a loan or consolidate a plurality of loans and/or credit account balances, etc. The analyzer component 210 can generate analysis results based at least in part on the analyzing, evaluating, and/or parsing of such information, and can provide the analysis results to another component(s) (e.g., offer management component 212, refinance management component 214, classifier component 222, etc.) for further processing.

The credit management component 200 can comprise an offer management component 212 that can evaluate approved financial offers directed to a consumer and received from respective financial service providers. Based at least in part on the results of the evaluation, the offer management component 212 can identify and select (e.g., automatically or dynamically identify and select) one or more desirable (e.g., a best or most preferred, or a subset of best or most preferred) approved financial offers, in accordance with the defined financial offer criteria. The credit management component 200, using the communication component 202 and/or another component(s) (e.g., notification component 228), can facilitate communicating the one or more desirable approved financial offers to a communication device associated with the consumer.

The credit management component 200 also can include a refinance management component 214 that can monitor and evaluate open loans, credit accounts, etc., associated with a consumer to facilitate determining whether to refinance (e.g., automatically refinance) a loan associated with the consumer, or refinance and consolidate a plurality of loans and/or credit account balances associated with the consumer to a new loan. Based at least in part on the results of the evaluation, the refinance management component 214 can determine (e.g., automatically or dynamically determine) whether to refinance a loan, or refinance and consolidate a plurality of loans and/or credit account balances to a new loan, in accordance with the defined financial offer criteria. For example, the refinance management component 214 can evaluate two loan balances having respective interest rates, and can evaluate approved loan offers (e.g., approved refinance loan offers) available to the consumer, to facilitate determining whether it is desirable (e.g., proper, beneficial, etc.) to refinance the two loans balances through a new approved loan based on an approved loan offer, in accordance with the defined financial offer criteria and/or user preferences of the potential offeree. If the refinance management component 214 determines that refinancing the two loan balances through a new approved loan meets the defined financial offer criteria and/or the user preferences, the refinance management component 214 can refinance automatically or dynamically, or in response to a consumer's instruction to accept the approved financial offer) the two loan balances to generate a new approved loan associated with the user.

The credit management component 200 also can contain a user data management component 216 that can collect, manage, and secure data associated with users (e.g., consumers, financial service providers, financial information providers, etc.) who are associated with (e.g., registered with, affiliated with, using, etc.) the open credit exchange platform. The user data management component 216 can make available financial-related information or other information to entities, such as the financial service providers, associated with the open credit exchange platform to facilitate enabling the financial service providers to accurately evaluate (e.g., estimate or score) the financial risk of making an approved financial offer to a consumer.

In some implementations, the user data management component 216 can control what information associated with consumers is exposed to financial service providers, for example, based at least in part on defined security criteria and/or user preferences of the consumer. The user data management component 216 can provide a desired level of anonymity to users (e.g., consumers) to hide or obscure a user's actual name or other user information from other entities (e.g., financial service providers) associated with the open credit exchange platform. For example, the user data management component 216 can generate (e.g., randomly generate) a pseudo ID name or number for a consumer that can be provided to other entities associated with the open credit exchange platform, instead of providing the consumer's actual name as an ID to the other entities.

The credit management component 200 also can include a security component 218 that can secure data associated with the open credit exchange platform and also can operate in conjunction with the user data management component 216 to facilitate securing such data. The security component 218 can operate in conjunction with the communication component 202 to establish a secure communication channel between the open credit exchange platform and communication devices associated with users (e.g., consumers, financial service providers, financial information providers, etc.), in accordance with a defined security protocol(s) and defined security criteria. For example, the security component 218 can establish a secure communication channel in accordance with a secure sockets layer (SSL) protocol and/or other cryptographic protocol. The security component 218 can encrypt data that is to be transmitted to a communication device, and can decrypt encrypted data received from a communication device, in accordance with an appropriate cryptographic protocol (e.g., a protocol relating to data encryption and decryption, public key cryptography, symmetric key, Public key infrastructure (PKI), Digital Signature Standard (DSS), Data Encryption Standard (DES), triple-DES, Advanced Encryption Standard (AES), cryptographic hash functions, etc.).

The security component 218 also can utilize authentication procedures to authenticate communication devices and associated users attempting to access the open credit exchange platform. For example, the security component 218 can control access to the open credit exchange platform based at least in part on verification of authentication credentials provided by communication devices of users. The security component 218 can grant certain access rights to a communication device of a user in response to verifying the authentication credentials presented by the communication device, wherein the access rights granted can be based at least in part on the particular user (e.g., type of user, such as consumer, financial service provider, financial information provider, etc.), the authentication credentials presented, and/or defined security criteria. For example, in accordance with the defined security criteria, the security component 218 can grant a consumer (and associated communication device) registered with the open credit exchange platform a first subset of access rights to the open credit exchange platform, and grant a financial service provider (and associated communication device) registered with the open credit exchange platform a second subset of access rights to the open credit exchange platform. Authentication credentials can include or be based at least in part on, for example, a username, a password, a personal identification number (PIN), biometric information (e.g., fingerprint information, eye or iris related information, facial recognition related information, etc.) associated with a user, a communication device identifier (e.g., Media Access Control (MAC) address) associated with a communication device, etc.

The security component 218 also can operate in conjunction with the user data management component 216 to facilitate generating (e.g., randomly generating) a pseudo ID name or number for a consumer that can be provided to other entities associated with the open credit exchange platform, instead of providing the consumer's actual name as an ID to the other entities. In some implementations, the security component 218 can use a random number generator component that can generate random or pseudo-random numbers that can be used to facilitate generating a pseudo ID name or number for a consumer.

The credit management component 200 can further include a data verification component 220 that can verify and/or identify confidence levels (e.g., accuracy, authenticity, trust, etc., levels) of respective pieces of data. In some implementations, the data verification component 220 can operate in conjunction with or can be part of the the user data management component 216 to facilitate identifying the reliability of the data (e.g., accuracy, authenticity, trustworthiness, etc., of the data) collected and managed by the user data management component.

The data verification component 220 can evaluate a piece of data, metadata associated with the piece of data, the type of data the piece of data is, the source of the piece of data, the age of the piece of data, other data potentially relevant to the piece of data (e.g., other data that can or may corroborate the accuracy, authenticity, trustworthiness, etc., of the piece of data), and/or other factors, and can verify the piece of data or identify a confidence level to assign the piece of data based at least in part on the evaluation. For example, the data verification component 220 can identify a piece of data as having a high level of accuracy and trustworthiness based at least in part on identifying that the piece of data is from a reputable source and/or the accuracy and trustworthiness of the information in the piece of data is corroborated by other data. The data verification component 220 can identify another piece of data as having a relatively low level of accuracy or trustworthiness based at least in part on identifying that this other piece of data is from a non-reputable or biased source (e.g., a consumer's job income as stated by the consumer) and/or the accuracy and trustworthiness of the information in the piece of data is not corroborated by other data (e.g., the consumer's job income, as stated by the consumer, is not corroborated or supported by other data evidencing that the consumer's job income is as the consumer stated). The data verification component 220 can assign a confidence level ranging, for example, from 0% (e.g., unverified or completely inaccurate) to 100% (e.g., completely accurate and/or verified), from low(est) confidence level (e.g., unverified or completely inaccurate) to high(est) confidence level (e.g., completely accurate and/or verified), and/or other types of confidence levels (e.g., respective color coding of respective confidence levels, such as, for example, green color to indicate verified and/or accurate data, yellow color to indicate a lower confidence level in the accuracy or trustworthiness of the data, and red color to indicate the lowest confidence level in the accuracy or trustworthiness of the data and/or to indicate that the data has not yet been evaluated for verification).

The credit management component 200 also can comprise a classifier component 222 that can classify or standardize financial products (e.g., approved financial offers) to facilitate enabling a user to do an informed comparison of the respective financial products (e.g., do an apples-to-apples comparison, instead of an apple-to-oranges comparison. For example, the classifier component 222 can take a first approved financial offer having a first set of financial terms or conditions and a second approved financial offer having a second set of financial terms or conditions, and can synthesize the information associated with the first and second approved financial offers to present them to the user in a way so as to facilitate enabling the user to do an informed comparison of the respective approved financial offers. For instance, the classifier component 222 can identify pertinent factors (e.g., monthly payment, number of months for repayment, effective interest rate, total repayment amount, etc.) for each of the first and second approved financial offers, and can present this information to the communication device of the user for comparison.

The credit management component 200 can further contain a financial account component 224 that can facilitate maintaining respective account information (e.g., financial account information, such as account number, outstanding balance, payment history, monthly payment amount, interest rate, etc.) of respective users (e.g., consumers, financial service providers, etc.), depositing funds to or withdrawing funds from a financial account of a user, transferring funds from one financial account to another financial account, adjusting a credit line or financial terms associated with a financial account, etc. For example, the financial account component 224 (e.g., operating in conjunction with the refinance management component 214 or other component) can facilitate generating a new financial account in relation to a refinance loan and can transfer outstanding balances of one or more financial accounts to the new financial account and/or close the one or more financial accounts after the transfer.

The financial account component 224 also can facilitate enabling a user to view and manage a digital wallet associated with the user's financial accounts recognized or maintained by the open credit exchange platform. For example, a user can use a communication device (e.g., via the financial application) to access, view, and/or manage the user's digital wallet and associated financial accounts, wherein the user can view a status (e.g., outstanding balance, payment status, etc.) or other information associated with a financial account, make payments on a financial account associated with the digital wallet, withdraw funds from or deposit funds to a financial account associated with the digital wallet, modify information associated with a financial account, etc.

The credit management component 200 also can comprise a mapper component 226 that can generate a mapping (e.g., in real or near real time) of an item(s) of data to another item(s) of data to facilitate enabling approved financial offers to be identified and provided to consumers. For example, the mapper component 226 can generate a mapping of consumer parameters (e.g., credit history of a consumer, current income of a consumer, current outstanding debt of a consumer, current debt-to-income ratio of the consumer, consumer behavior, current potential financial transaction of a consumer, etc.) identified for respective consumers to a set of approved financial offers (e.g., in relation to financial transactions) from respective financial service providers to facilitate identifying one or more approved financial offers for presentation to a consumer via the consumer's communication device. In some implementations, the mapper component 226 can generate a mapping of approved financial offers (e.g., generic approved financial offers not expressly directed to a consumer by a financial service provider) to consumers, based at least in part on the consumer parameters. For example, a financial service provider can provide, via a communication device, an approved financial offer, which is not specifically directed to a consumer by the financial service provider, to the open credit exchange platform, wherein the approved financial offer can have a set of qualifications for a consumer to be pre-approved to accept the approved financial offer. The mapper component 226 and/or another component(s) (e.g., analyzer component 210) of the credit management component 200 can evaluate the set of qualifications associated with the approved financial offer and respective consumer parameters of consumers, can identify one or more consumers who qualify for the approved financial offer, and can generate a mapping between the approved financial offer and the one or more qualifying consumers. The credit management component 200 can utilize this mapping to facilitate determining whether to present a consumer with the approved financial offer and/or notifying a financial service provider of consumers who meet the set of qualifications, wherein the financial service provider can determine whether to extend the approved financial offer to the one or more of the qualifying consumers.

The credit management component 200 can comprise a notification component 228 that can generate notifications relating to approved financial offers to facilitate notifying consumers of the approved financial offers. For instance, the notification component 228 can generate a notification of an approved financial offer (e.g., a best or most preferred approved financial offer) for a consumer, and the credit management component 200 (e.g., using the communicator component 202) can transmit this notification to a communication device associated with that consumer. The notification component 228 also can generate other types of notifications to facilitate providing information relating to a consumer's finances to the communication device associated with the consumer. For example, the notification component 228 can generate a notification relating to the financial health of a consumer (e.g., notification relating to the status of consumer's financial health, a change in the status of the consumer's financial health or strength, an automatic refinance of an account(s) or loan(s) of the consumer, etc.) or a notification relating to an action(s) a consumer can take to facilitate improving the consumer's financial health or strength. The notification component 228 also can generate a notification relating to selection of an approved financial offer made by a financial service provider. For example, the notification component 228 can generate a notification that the credit management component 200 selected an approved financial offer made by a financial service provider or a notification that a consumer accepted the approved financial offer, and the credit management component 200 can transmit such notification(s) to a communication device associated with the financial service provider to notify the financial service provider that the approved financial offer was selected or accepted.

The credit management component 200 also can contain a signature component 230 that can verify or authenticate an electronic signature of a user(s) (e.g., consumer, financial service provider, etc.) in relation to a contract (e.g., an electronic document that includes a contract) between a consumer and a financial service provider relating to an approved financial offer by the financial service provider to the consumer. The signature component 230 (e.g., operating in conjunction with the security component 218) can evaluate an electronic signature provided by a user and can determine whether the electronic signature provided by the user is valid or verified, in accordance with the defined security criteria. If the signature component 230 verifies an electronic signature of a consumer on a contract relating to an approved financial offer, for example, a legally binding contract can be created, and the financial benefits (e.g., monetary funds, credit line, etc.) associated with the approved financial offer can be provided (e.g., deposited) to a financial account of the consumer or applied to a financial transaction being made by the consumer.

The credit management component 200 can include a registration component 232 that can register users (e.g., consumers, financial service providers, financial information providers, etc.), with the open credit exchange platform. The registration component 232 can receive information from a communication device of a user or can generate information to facilitate registering users and/or generating authentication credentials for users to use when attempting to access the open credit exchange platform. For example, the registration component 232 can receive a user's (e.g., consumer's) personal information (e.g., name, address, phone number, etc.), job history, financial information associated with the user (e.g., income history, bank or credit account information, loan information, etc.), to facilitate registering the user with the open credit exchange platform. The registration component 232 also can receive information relating to authentication credentials from the user to facilitate generating authentication credentials for the user and/or can generate authentication credentials that can be assigned to the user. The registration component 232 also can register other types of users, such as financial service providers, financial information providers, etc., with the open credit exchange platform, wherein the registration component 232 can receive or generate respective items of information associated with respective users to facilitate registering the respective users with the open credit exchange platform and/or generating or assigning respective authentication credentials to the respective users. For each of the respective users, the registration component 232 can generate a user profile and can store information associated with the user in the user profile of the user, wherein the registration component 232 can store user profiles in the data store 240.

The credit management component 200 can further comprise an application component 234 that can generate, update, and/or use one or more applications to facilitate operation of the open credit exchange platform, access or use of the open credit exchange platform by communication devices of users. In some implementations, the application component 234 or another component of the credit management component 200 can provide respective applications (e.g., financial applications) to respective communication devices of respective users, wherein the communication devices can use the respective applications to facilitate accessing and using the open credit exchange platform. The application (e.g., consumer financial application) used for a communication device associated with one type of user (e.g., consumer) can be the same as or different from an application (e.g., FSP financial application) used for a communication device associated with another type of user (e.g., financial service provider, and/or an application used for one type of communication device (e.g., desktop computer) can be the same as or different from an application (e.g., mobile application) used for another type of communication device (e.g., mobile phone, electronic pad or tablet).

The credit management component 200 also can include an instruction component 236 that can evaluate information (e.g., financial information, such as, for example, credit history, consumer behavior, current income, current debt obligations, current financial strength or health, etc.) of the consumer to identify one or more recommended actions that the consumer can or may take to facilitate improving the consumer's financial strength or health. A recommended action can include information relating to the type(s) of action(s) or step(s) the consumer can take, a reason(s) why the recommended action can be beneficial to the consumer, an expected or estimated value of the benefit that can be obtained by the recommended action, or other information. The instruction component 236 (e.g., via the communication component 202) can provide the one or more recommended actions to the consumer via the consumer's communication device.

The credit management component 200 also can comprise a processor component 238 that can work in conjunction with the other components (e.g., communication component 202, interface component 204, monitor component 206, etc.) to facilitate performing the various functions of the credit management component 200. The processor component 238 can employ one or more processors, microprocessors, or controllers that can process data, such as information (e.g., financial-related information) relating to users associated with the open credit exchange platform, information relating to cryptography or authentication (e.g., information relating to defined security, cryptographic, and/or authentication protocols), information relating to other operations of the credit management component 200, and/or other information, etc., to facilitate operation of the credit management component 200, as more fully disclosed herein, and control data flow between the credit management component 200 and other components (e.g., other components of or associated with the credit management component 200).

The credit management component 200 also can include a data store 240 that can store data structures (e.g., user data, metadata), code structure(s) (e.g., modules, objects, hashes, classes, procedures) or instructions, information (e.g., financial-related information) relating to users associated with the open credit exchange platform, information relating to cryptography or authentication (e.g., information relating to defined security, cryptographic, and/or authentication protocols), information relating to other operations of the credit management component 200, and/or other information, etc., to facilitate controlling operations associated with the credit management component 200. In an aspect, the processor component 238 can be functionally coupled (e.g., through a memory bus) to the data store 240 in order to store and retrieve information desired to operate and/or confer functionality, at least in part, to the communication component 202, interface component 204, monitor component 206, etc., and/or substantially any other operational aspects of the credit management component 200.

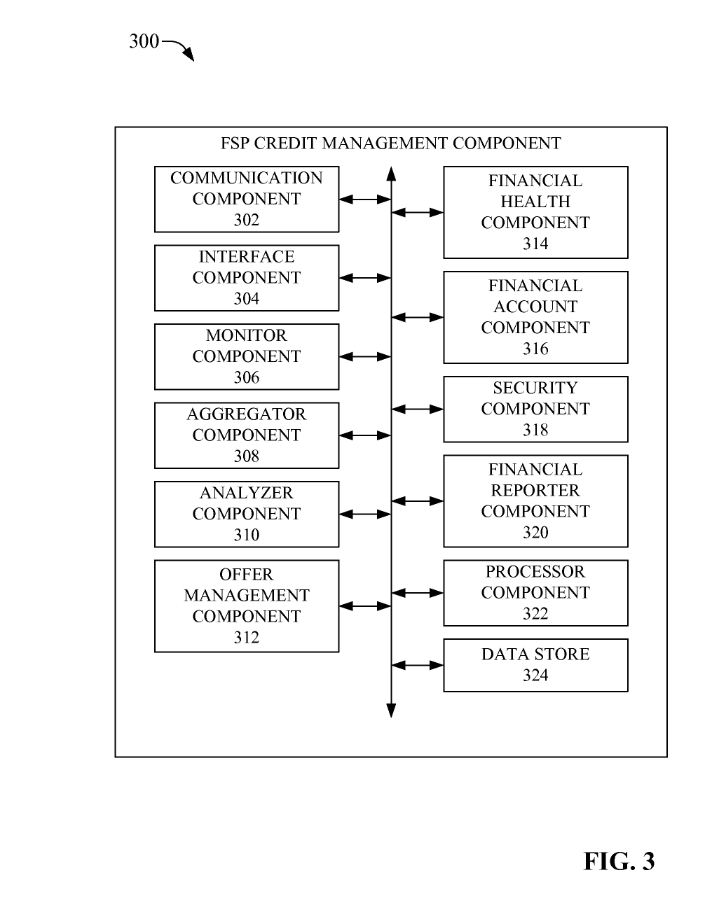

FIG. 3 illustrates a block diagram of an example FSP credit management component 300, in accordance with various aspects and embodiments of the disclosed subject matter. The FSP credit management component 300 can be associated with (e.g., communicatively connected to) an open credit exchange platform and/or communication devices associated with consumers, for example. The FSP credit management component 300 can be associated with, managed, operated, and/or utilized by a financial service provider.

The FSP credit management component 300 can comprise a communication component 302 that can communicate (e.g., transmit, receive) information, including financial-related information associated with the financial service provider and/or users (e.g., consumers), information relating to approved financial offers, and/or other information, between the FSP credit management component 300 and other components or devices, such as the open credit management platform (e.g., a communication device of or associated with the open credit management platform), communication devices associated with other financial service providers, communication devices associated with financial information providers, and/or communication devices associated with users. The communicator component 302 can employ one or more communication protocols to facilitate controlling data or voice flows, and/or wireless or wireline communication of traffic (e.g., voice or data traffic), associated with the FSP credit management component 300.

The FSP credit management component 300 can include an interface component 304 that can comprise one or more interfaces, including one or more controls, switches, adapters, connectors, buttons, routers, speakers, display screens, GUIs, and/or touch screen GUIs, etc., that can facilitate enabling the FSP credit management component 300 to interface and/or communicate with other systems, components, or devices (e.g., open credit management platform; communication devices associated with consumers, financial service providers, or financial information providers; systems, components, or devices associated with a communication network(s); etc.), or users (e.g., system administrators, engineers, technicians, etc.) associated with the FSP credit management component 300 and/or the associated financial service provider. The interface component 304 can facilitate establishing a communication channel (e.g., a secure wireless or wireline communication channel) between the FSP credit management component 300 and the open credit management platform or a communication device associated with a consumer, another financial service provider, financial information provider, etc.

The FSP credit management component 300 can comprise a monitor component 306 that can monitor (e.g., continuously, periodically, dynamically (e.g., in response to a condition for monitoring information being met), etc.) information in real or near real time. The monitor component 306 can monitor, for example, financial-related information associated with respective consumers (e.g., as obtained from the open credit exchange platform, as directly obtained by the FSP credit management component 300, as obtained from communication devices of other financial service providers, as obtained from communication devices of financial information providers, as obtained from consumers (e.g., via communication devices of consumers), etc.). For instance, the open credit exchange platform can provide or make available the defined N financial-related parameters relating to one or more consumers to facilitate evaluation of financial-related information of the one or more consumers by the financial service provider(s). The monitor component 306 can monitor the financial-related parameters to facilitate updating the financial-related information of the one or more consumers in the data store 324, identifying a financial health or strength of a consumer, identifying an approved financial offer to be presented to a consumer, etc.

The FSP credit management component 300 also can contain an aggregator component 308 that can aggregate or collect the information (e.g., financial-related information, approved financial offers, consumer financial history, consumer preferences, etc.). For instance, the aggregator component 308 can aggregate information received (e.g., obtained) from various entities (e.g., open credit exchange platform, monitor component 306 or another component(s) of the FSP credit management component 300, communication network, an application (e.g., a mobile or web application), a server or other communication device, processor, data store, etc.). The aggregator component 308 can correlate respective items of data based at least in part on type of data (e.g., information relating to a particular financial transaction, information relating to a particular financial offer, metadata, etc.), consumer to which the data relates, source of the data, time or date the data was generated or received, etc., to facilitate analyzing or evaluating of the data by the analyzer component 310 or another component of the FSP credit management component 300.

The analyzer component 310 can analyze, evaluate, and/or parse information (e.g., financial-related information, defined financial assessment criteria, etc.) to facilitate identifying a financial health or strength of a consumer, identifying an approved financial offer to be presented to a consumer, modifying (e.g., updating) a user profile relating to a user (e.g., consumer), etc. The analyzer component 310 can generate analysis results based at least in part on the analyzing, evaluating, and/or parsing of such information, and can provide the analysis results to another component(s) (e.g., offer management component 312, processor component 322, data store 324, etc.) for further processing.

The FSP credit management component 300 can comprise an offer management component 312 that, for respective consumers, can identify or evaluate financial-related information and/or the financial health associated with a consumer, and can identify one or more approved financial offers that can be directed to the consumer, based at least in part on the financial-related information and/or the financial health associated with the consumer. For instance, the offer management component 312 can receive the analysis results from the analyzer component 310, and can evaluate the analysis results. The offer management component 312 can identify and select (e.g., automatically or dynamically identify and select) the one or more approved financial offers that can be made to the consumer, based at least in part on the evaluation of the analysis results, in accordance with the defined financial assessment criteria associated with the financial service provider. The offer management component 312 also can generate contracts, comprising the contract terms, associated with the approved financial offers, wherein a contract can be provided or presented (e.g., by the FSP credit management component 300 or the open credit exchange platform) with an approved financial offer or in response to acceptance of the approved financial offer by the consumer. The FSP credit management component 300, using the communication component 302 and/or another component(s), can facilitate communicating the one or more approved financial offers to, for example, the open credit exchange platform.

The FSP credit management component 300 also can include a financial health component 314 that, for respective consumers, can identify a financial health or strength of a consumer. The financial health component 314 can identify the financial health or strength of a consumer, based at least in part on its own analysis or evaluation of financial-related information associated with a consumer (or that of another component (e.g., the analyzer component 310) of the FSP credit management component 300), a financial health or strength assessment or score from the open credit exchange platform, and/or a financial health or strength assessment or score from another entity (e.g., a financial information provider).

The FSP credit management component 300 also can contain a financial account component 316 that can collect, manage, and secure data (e.g., financial-related information) associated with consumers who are associated with (e.g., registered with, engaged in business with, potentially engaged in business with, etc.) the financial service provider associated with the FSP credit management component 300. For instance, the financial account component 316 can facilitate maintaining respective account information (e.g., financial account information, such as account number, outstanding balance, payment history, monthly payment amount, interest rate, etc.) of respective users (e.g., consumers), applying monetary payments to or withdrawing monetary funds from a financial account of a user (e.g., in accordance with an accepted approved financial offer), adjusting a credit line or financial terms associated with a financial account of a user, etc. The financial account component 316 can create and manage respective user profiles or accounts for respective consumers, and the respective user profiled or accounts can be stored in the data store 324.

The FSP credit management component 300 also can include a security component 318 that can secure data associated with the FSP credit management component 300. The security component 318 can operate in conjunction with the communication component 302 to establish a secure communication channel between the FSP credit management component 300 and the open credit exchange platform or communication devices associated with users (e.g., consumers, financial service providers, financial information providers, etc.), in accordance with a defined security protocol(s) and defined security criteria. For example, the security component 318 can establish a secure communication channel in accordance with an SSL protocol and/or other cryptographic protocol. The security component 318 can encrypt data that is to be transmitted to a communication device, and can decrypt encrypted data received from a communication device, in accordance with an appropriate cryptographic protocol(s) (e.g., a protocol(s) relating to data encryption and decryption, public key cryptography, symmetric key, PKI, DSS, DES, triple-DES, AES, cryptographic hash functions, etc.).

The security component 318 also can utilize authentication protocols to authenticate communication devices and associated users attempting to access the FSP credit management component 300. For example, the security component 318 can control access to the FSP credit management component 300 based at least in part on verification of authentication credentials provided by communication devices of the open credit exchange platform and/or users. The security component 318 can grant certain access rights to a communication device of a user in response to verifying the authentication credentials presented by the communication device of the user, wherein the access rights granted can be based at least in part on the particular user (e.g., type of user, such as a user associated with the open credit management platform, a consumer, a financial service provider, a financial information provider, etc.), the authentication credentials presented, and/or the defined security criteria. For example, in accordance with the defined security criteria, the security component 318 can grant a consumer (and associated communication device), who is registered with the FSP credit management component 300, a first subset of access rights to the FSP credit management component 300, and grant a user, who is associated with the open credit exchange platform (and associated communication device) that is associated with the FSP credit management component 300, a second subset of access rights to the FSP credit management component 300. Authentication credentials can include or be based at least in part on, for example, a username, a password, a PIN, biometric information (e.g., fingerprint information, eye or iris related information, facial recognition related information, etc.) associated with a user, a communication device identifier (e.g., MAC address) associated with a communication device, etc. In some implementations, the security component 318 can use a random or pseudo-random number generator component that can generate (e.g., randomly or pseudo-randomly generate) random or pseudo-random numbers, which can be used to facilitate securing data, in accordance with the defined security criteria.

The FSP credit management component 300 can contain a financial reporter component 320 that can facilitate reporting of information (e.g., financial-related information) to the open credit exchange platform or another component(s) (e.g., communication device associated with a financial service provider, financial information provider, or other entity) associated with the FSP credit management component 300. For instance, the financial reporter component 320 can provide and/or update information relating to a consumer to the open credit exchange platform to facilitate enabling the open credit exchange platform to identify or update financial-related information relating to the consumer, identify or update a financial health or strength of the consumer, identify or update information relating to a financial account of the consumer, etc.

The FSP credit management component 300 also can comprise a processor component 322 that can work in conjunction with the other components (e.g., communication component 302, interface component 304, monitor component 306, etc.) to facilitate performing the various functions of the FSP credit management component 300. The processor component 322 can employ one or more processors, microprocessors, or controllers that can process data, such as information (e.g., financial-related information) relating to users associated with the FSP credit management component 300, information relating to determinations regarding whether to issue an approved financial offer, information relating to determination of the terms of an approved financial offer, information relating to cryptography or authentication (e.g., information relating to defined security, cryptographic, and/or authentication protocols), information relating to the defined financial assessment criteria, information relating to the defined security criteria, information relating to other operations of the FSP credit management component 300, and/or other information, etc., to facilitate operation of the FSP credit management component 300, as more fully disclosed herein, and control data flow between the FSP credit management component 300 and other components (e.g., other components of or associated with the FSP credit management component 300).

The FSP credit management component 300 also can include a data store 324 that can store data structures (e.g., user data, metadata), code structure(s) (e.g., modules, objects, hashes, classes, procedures) or instructions, information relating to determinations regarding whether to issue an approved financial offer, information relating to determination of the terms of an approved financial offer, information relating to cryptography or authentication (e.g., information relating to defined security, cryptographic, and/or authentication protocols), information relating to the defined financial assessment criteria, information relating to the defined security criteria, information relating to other operations of the FSP credit management component 300, and/or other information, etc., to facilitate controlling operations associated with the FSP credit management component 300. In an aspect, the processor component 322 can be functionally coupled (e.g., through a memory bus) to the data store 324 in order to store and retrieve information desired to operate and/or confer functionality, at least in part, to the communication component 302, interface component 304, monitor component 306, etc., and/or substantially any other operational aspects of the FSP credit management component 300.

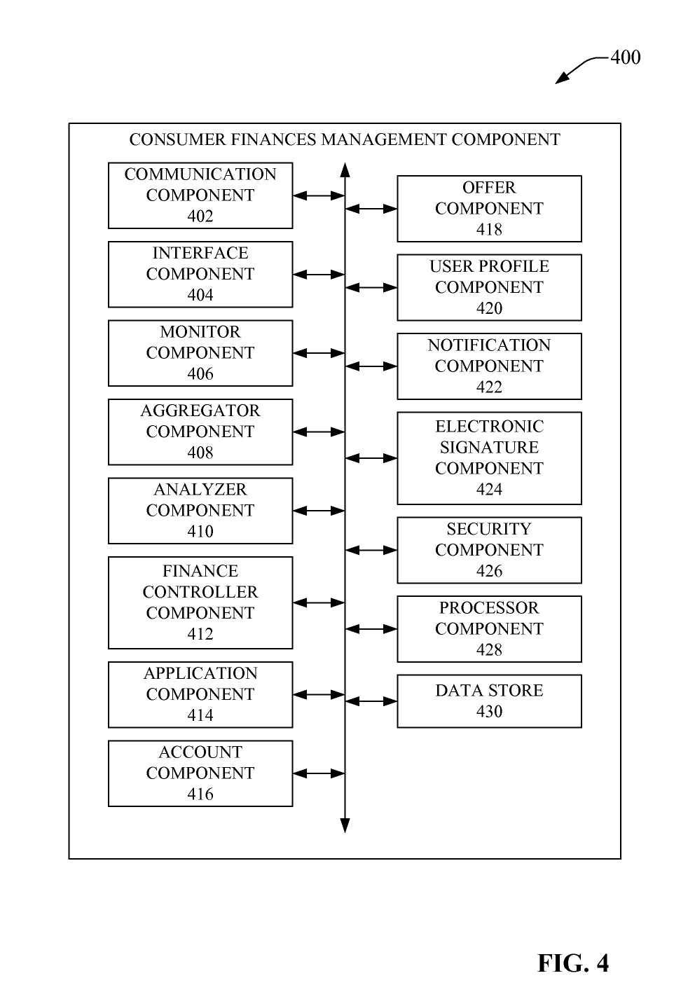

FIG. 4 depicts a a block diagram of an example consumer finances management component 400 in accordance with various aspects and embodiments of the disclosed subject matter. The consumer finances management component 400 can be part of or associated with a communication device (e.g., mobile phone, computer, etc.) associated with a user (e.g., consumer). In some implementations, various aspects or functions of the consumer finances management component 400 can be facilitated using an application (e.g., a locally based or mobile application, a web based application).

The consumer finances management component 400 can comprise a communication component 402 that can communicate (e.g., transmit, receive) information, including financial-related information associated with a user (e.g., consumer), information relating to approved financial offers or associated contracts, and/or other information, between the consumer finances management component 400 and other components or devices, such as the open credit management platform (e.g., a communication device of or associated with the open credit management platform), communication devices associated with financial service providers, and/or communication devices associated with financial information providers. The communicator component 402 can employ one or more communication protocols to facilitate controlling data or voice flows, and/or wireless or wireline communication of traffic (e.g., voice or data traffic), associated with the consumer finances management component 400.

The consumer finances management component 400 can include an interface component 404 that can comprise one or more interfaces, including one or more controls, switches, adapters, connectors, buttons, routers, speakers, display screens, GUIs, and/or touch screen GUIs, etc., that can facilitate enabling the consumer finances management component 400 to interface and/or communicate with other systems, components, or devices (e.g., open credit management platform; communication devices associated with financial service providers or financial information providers; systems, components, or devices associated with a communication network(s); etc.). The interface component 404 can facilitate establishing a communication channel (e.g., a secure wireless or wireline communication channel) between the consumer finances management component 400 and the open credit management platform or a communication device associated with a financial service provider, financial information provider, etc.

The consumer finances management component 400 can comprise a monitor component 406 that can monitor (e.g., continuously, periodically, dynamically (e.g., in response to a condition for monitoring information being met)) information in real or near real time. The monitor component 406 can monitor information communications to facilitate detecting and identifying, for example, financial-related information, including approved financial offers, contracts relating to approved financial offers, notifications relating to approved financial offers, notifications relating to refinancing of a financial account(s) or debt(s) of a user of the communication device, notifications relating to financial strength or health of the user, etc. For instance, the monitor component 406 can be monitoring information communications associated with the communication device, comprising the consumer finances management component 400. The monitor component 406 can identify or detect an approved financial offer being made to the user associated with the communication device or a notification relating to financial-related information associated with the user and can facilitate providing information relating to the approved financial offer or the notification to the user via an interface(s) associated with the interface component 404.

The consumer finances management component 400 also can contain an aggregator component 408 that can aggregate or collect information (e.g., financial-related information, approved financial offers, user preferences, etc.) received or maintained by the communication device. For instance, the aggregator component 408 can aggregate information received (e.g., obtained) from various entities (e.g., open credit exchange platform, monitor component 406 or another component(s) of the consumer finances management component 400, communication network, an application (e.g., a mobile or web application), a server or other communication device, processor, data store, etc.). The aggregator component 408 can correlate respective items of data based at least in part on type of data (e.g., information relating to a particular financial transaction, information relating to a particular approved financial offer, metadata, etc.), source of the data, time or date the data was generated or received, etc., to facilitate analyzing or evaluating of the data by the analyzer component 410 or another component of the consumer finances management component 400.

The analyzer component 410 can analyze, evaluate, and/or parse information (e.g., financial-related information, etc.) associated with the user (e.g., consumer) to facilitate identifying current assets and debts (e.g., identifying total assets and debts, identifying a subset of assets and debts), modifying (e.g., updating) a user profile relating to the user, identifying a financial health or strength of a consumer, etc. The analyzer component 410 can generate analysis results based at least in part on the analyzing, evaluating, and/or parsing of such information, and can provide the analysis results to another component(s) (e.g., finance controller component 412, processor component 428, data store 430, etc.) for further processing.

The consumer finances management component 400 also can comprise a finance controller component 412 that can control operations associated with the various components of the consumer finances management component 400. For instance, the finance controller component 412 can control operations of the consumer finances management component 400 to facilitate identifying and presenting approved financial offers, contracts associated with approved financial offers, electronic signatures relating to such contracts, notifications relating financial-related information, etc., by the consumer finances management component 400 to facilitate presentation of such information to the user of the communication device. The finance controller component 412 also can facilitate controlling data flow between the various components (e.g., communication component 402, interface component 404, monitor component 406, etc.) of the consumer finances management component 400 to facilitate performing the various operations of the consumer finances management component 400.

The consumer finances management component 400 also can include an application component 414 that can comprise an application(s) (e.g., financial application) that can be utilized by the communication device to facilitate interaction (e.g., communication of financial-related information) between the communication device and the open credit exchange platform, financial service providers, financial information providers, etc., creating and maintaining a digital wallet associated with the user of the communication device, executing (e.g., electronic signing and accepting) of contracts relating to approved financial offers, debt monitoring associated with the user, monitoring of financial health or strength associated with the user, monitoring of credit history associated with the user, etc. For instance, the application component 414 can facilitate generating a digital wallet that can aggregate all or a desired portion of financial accounts (e.g., bank accounts, credit accounts, loan accounts, etc.) and available approved financial offers for presentation of information relating to these financial accounts and approved financial offers to the user (e.g., via an interface associated with the application component 414).

The consumer finances management component 400 can comprise an account component 416 that can maintain information relating to the financial accounts and available approved financial offers for presentation of information relating to these financial accounts and approved financial offers. The account component 416 can comprise the digital wallet, for example. The digital wallet can contain and present information relating to the assets and debts of the user, and approved financial offers available to the user. The account component 416 can be generated based at least in part by using an application(s) associated with the application component 414.

The consumer finances management component 400 can contain an offer component 418 that can facilitate managing financial offers, such as approved financial offers, being presented to the user associated with the communication device by the open credit exchange platform and/or a financial service provider. The offer component 418 can provide (e.g., present) the terms (e.g., amount of funds available, interest rate, fee(s), installment payment amount, repayment period, etc.) of an approved financial offer, a contract relating to the approved financial offer, and/or other information relating to the approved financial offer. In some implementations, the offer component 418 can provide the approved financial offers in a standardized format to facilitate making it easier for the user to comprehend the respective terms of approved financial offers and/or making it easier for the user to compare different approved financial offers with each other.

The consumer finances management component 400 can include a user profile component 420 that can be employed to generate a user profile for the user associated with the communication device. The user profile can include financial-related information associated with the user, identifying information associated with the user, user preferences associated with the user, etc. For example, the user profile can include user preferences that can specify criteria (e.g., financial offer related criteria) of the user that can facilitate managing presentation of approved financial offers, refinancing of debts associated with the user, etc. The user profile also can include user preferences relating to privacy or security of information relating to the user. For instance, the user profile component 420 can include user preferences relating to information security that can facilitate controlling what information of the user is exposed to the open credit exchange platform, financial service providers, financial information providers, etc.

The consumer finances management component 400 can comprise a notification component 422 that can facilitate generating and/or presenting of notifications relating to approved financial offers, refinancing of debts (e.g., refinancing of a loan(s)), financial health or strength, improving the financial health or strength, etc., associated with the user. The notification component 422 can receive notification messages from, for example, the open credit exchange platform, wherein the notification messages can notify the user of an approved financial offer being extended to the user by a financial service provider, notify the user of a refinancing of debts of the user (e.g., performed by the open credit exchange platform) or an opportunity to refinance debts of the user, notify the user of a change in the financial health or strength of the user, notify the user of instructions to facilitate improving the financial health or strength of the user, etc. The notification component 422 can generate and present (e.g., via an interface(s) of the user's communication device) a notification or alert signal (e.g., message; audial, visual, or other sensory indicator (e.g., vibration of the user's communication device); etc.), based at least in part on, and in response to, the notification message received from the open credit exchange platform, in accordance, for example, with the user preferences of the user. The notification component 422 can generate respective (e.g., different) types of notifications or alerts based at least in part on the type of notification message received from the open credit exchange platform. For example, the notification component 422 can generate and present a first type of alert (e.g., first type of visual, audial, and/or other sensory alert) for a first type of notification (e.g., a notification relating to an approved financial offer), and a second type of alert (e.g., second type of visual, audial, and/or other sensory alert) for a second type of notification (e.g., a notification relating to a change in the financial health or strength of the user).

The consumer finances management component 400 can contain an electronic signature component 424 that can facilitate enabling the user to electronically sign contracts (e.g., electronic document comprising a contract) relating to approved financial offers that are being accepted by the user and/or other electronic documents for which an electronic signature is desired or required. An electronically signed contract can be a legally binding contract between the user and the financial service provider that made the approved financial offer. In some implementations, the electronic signature component 424 can operate in conjunction with the security component 426 to facilitate applying an electronic signature to an electronic document (e.g., contract) in a secure manner, ensuring that the electronic signature is actually being made by the user or other authorized entity (e.g., using an authentication protocol(s)), etc.

The consumer finances management component 400 can include a security component 426 that can secure data associated with the consumer finances management component 400. In some implementations, the security component 426 can facilitate controlling what information of the user is exposed to the open credit exchange platform, financial service providers, financial information providers, etc., in accordance with user preferences contained in the user profile of the user or dynamically selected user preferences of the user. The security component 426 can operate in conjunction with the communication component 402 to establish a secure communication channel between the communication device and the open credit exchange platform and/or communication devices associated with financial service providers, financial information providers, etc., in accordance with a defined security protocol(s) and defined security criteria. For example, the security component 426 can establish a secure communication channel in accordance with an SSL protocol and/or other cryptographic protocol. The security component 426 can encrypt data that is to be transmitted to a communication device, and can decrypt encrypted data received from a communication device, in accordance with an appropriate cryptographic protocol (e.g., a protocol relating to data encryption and decryption, public key cryptography, symmetric key, PM, DSS, DES, triple-DES, AES, cryptographic hash functions, etc.).

In some implementations, the security component 426 can employ a defined authentication protocol(s) to facilitate authenticating an entity (e.g., a user) attempting to access the application, securing the digital wallet (and information or accounts therein) and authenticating an entity attempting to access the digital wallet, authenticating an entity attempting to apply a digital signature to an electronic document, etc. For example, the security component 426 can control access to the application or digital wallet, and/or control applying of an electronic signature to an electronic document, based at least in part on authentication information (e.g., authentication credentials) received from an entity, in accordance with a defined authentication protocol. If the security component 426 verifies the received authentication information in relation to stored authentication information associated with the entity (e.g., if the received authentication information matches the stored authentication information), the security component 426 can grant a subset of access rights to the application or digital wallet to the entity, or apply an electronic signature of the entity to the electronic document, in accordance with the defined authentication protocol. If the security component 426 is not able to verify the received authentication information in relation to the stored authentication information associated with the entity (e.g., if the received authentication information does not match the stored authentication information), the security component 426 can deny access rights to the application or digital wallet to the entity, or can deny application of an electronic signature of the entity to the electronic document, in accordance with the defined authentication protocol.

The consumer finances management component 400 also can comprise a processor component 428 that can work in conjunction with the other components (e.g., communication component 402, interface component 404, monitor component 406, etc.) to facilitate performing the various functions of the consumer finances management component 400. The processor component 428 can employ one or more processors, microprocessors, or controllers that can process data, such as information (e.g., financial-related information) relating to a user(s) associated with the consumer finances management component 400, information relating to user preferences, information relating to cryptography or authentication (e.g., information relating to defined security, cryptographic, and/or authentication protocols), information relating to the defined financial offer criteria, information relating to the defined security criteria, information relating to other operations of the consumer finances management component 400, and/or other information, etc., to facilitate operation of the consumer finances management component 400, as more fully disclosed herein, and control data flow between the consumer finances management component 400 and other components (e.g., other components of or associated with the consumer finances management component 400).

The consumer finances management component 400 also can include a data store 430 that can store data structures (e.g., user data, metadata), code structure(s) (e.g., modules, objects, hashes, classes, procedures) or instructions, information (e.g., financial-related information) relating to a user(s) associated with the consumer finances management component 400, information relating to user preferences, information relating to cryptography or authentication (e.g., information relating to defined security, cryptographic, and/or authentication protocols), information relating to the defined financial offer criteria, information relating to the defined security criteria, information relating to other operations of the consumer finances management component 400, and/or other information, etc., to facilitate controlling operations associated with the consumer finances management component 400. In an aspect, the processor component 428 can be functionally coupled (e.g., through a memory bus) to the data store 430 in order to store and retrieve information desired to operate and/or confer functionality, at least in part, to the communication component 402, interface component 404, monitor component 406, etc., and/or substantially any other operational aspects of the consumer finances management component 400.

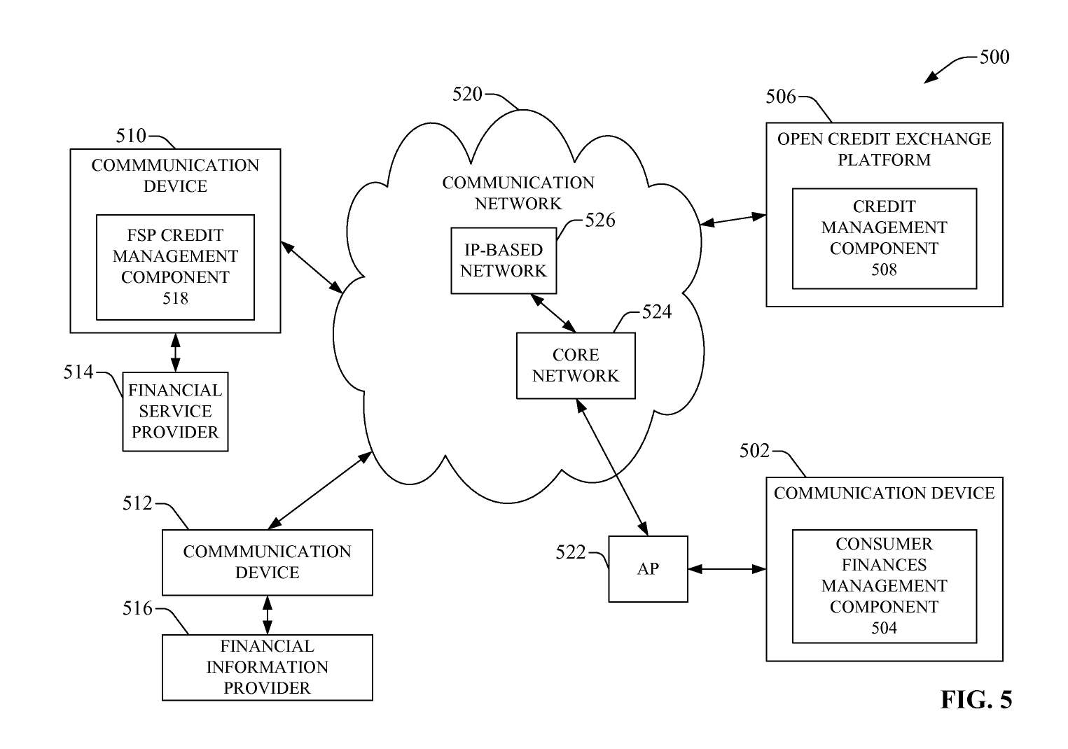

FIG. 5 illustrates a diagram of an example system 500 that can facilitate processing of financial offers (e.g., approved financial offers) and providing financial offers to communication devices associated with users (e.g., consumers), in accordance with various aspects and embodiments described herein. In an aspect, the system 500 can include a communication device 502 that can communicate (e.g., voice, data) other communication devices associated with the system 500 in a communication network environment. The communication device can include a consumer finances management component 504 that can facilitate enabling a user (e.g., consumer) to monitor, manage, execute, etc., financial transactions associated with the user, as more fully disclosed herein.

The system 500 can include an open credit exchange platform 506, which can include a credit management component 508 that can manage and process financial transactions associated with consumers and financial service providers, identify and select approved financial offers (e.g., best or most preferred approved financial offer(s)) for presentation to consumers, refinance an account(s) associated with a consumer, collect financial-related information associated with consumers, assess the financial health of a user, make certain financial-related information available to financial service providers, instruct the consumer as to how to improve the consumer's financial health, register users (e.g., consumers, financial service providers, financial information providers, other information providers, etc.) with the open credit exchange platform 506, and/or perform other functions, as more fully disclosed herein. The open credit exchange platform 506 be or can comprise a communication device and can communicate with other communication devices, such as communication device 502, associated with the system 500 in the communication network environment.

The system 500 also can contain one or more other communication devices, including communication device 510 and communication device 512, which can be respectively associated with one or more financial service providers, such as financial service provider 514, and one or more financial information providers, such as financial information provider 516. The financial service provider(s) 514 can provide financial services (e.g., bank accounts, loans, credit accounts, etc.) to consumers. The communication device 510 associated with the financial service provider 514 can include an FSP credit management component 518 that can manage financial transactions and financial accounts associated with consumers, evaluate the financial strength and/or creditworthiness of consumers, generate approved financial offers that can be presented to users (e.g., in accordance with the defined financial assessment criteria associated with the financial service provider 514), and/or perform other functions, as more fully disclosed herein. The financial information provider(s) 516 can collect information relating to consumers and/or financial service providers, and can provide that information to other entitities, such as the open credit exchange platform 506, consumers, financial service providers, etc.

The system 500 can comprise a communication network 520 that can be employed to facilitate communication of voice and data between the communication device 502, the open credit exchange platform 504, communication device 510, communication device 512, or other communication devices associated with the communication network 520. Each of the communication devices (e.g., communication device 502, communication device associated with the open credit exchange platform 506, communication device 510, communication device 512, etc.) can connect to the communication network 520 via a wireline or wireless communication connection. The communication network 520 can comprise or be associated with a number of access points (APs) (e.g., base station), including AP 522, wherein the AP 522 can facilitate wireless connection of a communication device (e.g., 502) with the communication network 520, when a wireless communication connection is desired.

In accordance with various aspects, as a communication device (e.g., 502) is moved through a wireless communication network environment, at various times, the communication device can be connected (e.g., wirelessly connected) to one of a plurality of APs (e.g., macro or cellular AP, femto AP, pico AP, Wi-Fi AP, Wi-Max AP, etc.), such as the AP 522, that can operate in the wireless communication network environment. An AP (e.g., 522) can serve a specified coverage area to facilitate communication by the communication device or other communication devices in the wireless communication network environment. The AP can serve a respective coverage cell (e.g., macrocell, femtocell, picocell, etc.) that can cover a respective specified area, and the AP can service mobile wireless devices (e.g., communication device 502) located in the respective area covered by the respective cell, where such coverage can be achieved via a wireless link (e.g., uplink (UL), downlink (DL)). When an attachment attempt is successful, the communication device can be served by the AP and incoming voice and data traffic can be paged and routed to the communication device through the AP, and outgoing voice and data traffic from the communication device can be paged and routed through the AP to other communication devices in the communication network environment. In an aspect, the communication device can be connected and can communicate wirelessly using virtually any desired wireless technology, including, for example, cellular, Wi-Fi, Wi-Max, wireless local area networks (WLAN), etc.

In another aspect, the communication network 520 can comprise a core network 524 (e.g., mobile core network) that can be employed to facilitate communication (e.g., voice, data) by wireless communication devices (e.g., 502) associated (e.g., wirelessly connected) with the core network 524, via the AP 522, and other communication devices (e.g., communication device associated with the open credit exchange platform 506, communication device 510, communication device 512, etc.) associated with the communication network 520. The core network 524 can facilitate routing voice and data communications between communication devices (e.g., communication device 502, communication device associated with the open credit exchange platform 506, communication device 510, communication device 512, and/or communication devices associated with an IP-based network 526 (e.g., the Internet)) associated with the communication network 520. The core network 524 also can allocate resources to the a wireless communication device(s) (e.g., 502) associated with the core network 524, convert or enforce protocols, establish and enforce Quality of Service (QoS) for the wireless communication devices, provide applications or services in the network, translate signals, and/or perform other desired functions to facilitate system interoperability and communication in the wireless communication network. The core network 524 further can include desired components, such as routers, nodes, switches, interfaces, controllers, etc., that can facilitate communication of data between communication devices associated with the communication network 520.

The communication network 520 also can include the IP-based network 526 that can be associated with the core network 524 and can facilitate communications by communication devices associated with the communication network 520 at least in part via communication of data packets (e.g., IP-based data packets) between communication devices that are associated with the communication network 520 using a wired or wireless communication connection in accordance with specified IP protocols. The IP-based network 526 further can include desired components, such as routers, nodes, switches, interfaces, controllers, etc., that can facilitate communication of data between communication devices associated with the communication network 520. In an aspect, a wireline communication connection between a communication device (e.g., communication device 502, communication device associated with the open credit exchange platform 506, communication device 510, communication device 512, etc.) and the IP-based network 526 can be a communication connection that can communicate voice or data, and/or can be a DSL-type or broadband connection facilitated via an Ethernet connection, and/or a wireless communication connection can be facilitated via a connection of the wireless communication device (e.g., 502) to an AP (e.g., 522). In accordance with various aspects, a communication device can transmit voice calls or data (e.g., messages) via a wireline or wireless connection through the IP-based network 526, the core network 524, or other communication networks, to another communication device(s).

In accordance with yet another aspect, the communication device 502 and another communication device (e.g., communication device associated with the open credit exchange platform 506, communication device 510, etc.) can establish a direct communication channel with each other to exchange information, such as information relating to a financial transaction (e.g., purchase of a product or service, transaction relating to an approved financial offer, etc.), using NFC or other communication technology, as more fully described herein.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

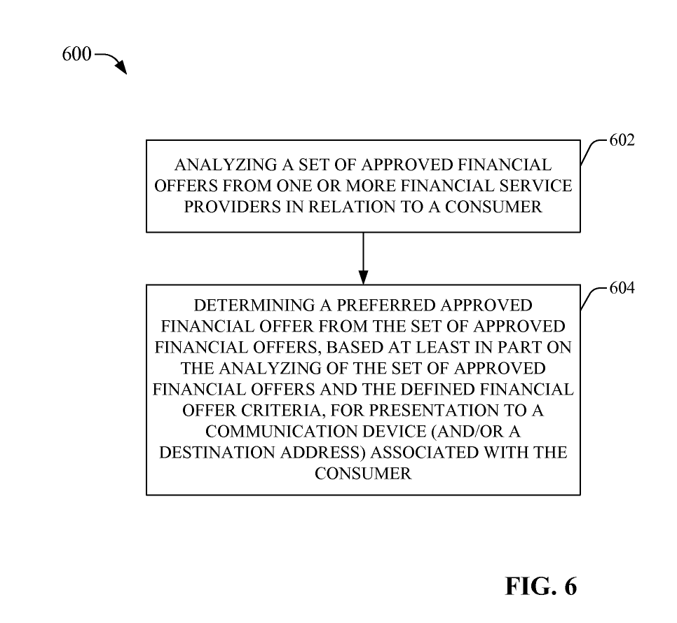

In view of the example systems described above, example methods that can be implemented in accordance with the disclosed subject matter can be better appreciated with reference to flowcharts in FIGS. 6-12. For purposes of simplicity of explanation, various methods disclosed herein are presented and described as a series of acts; however, it is to be understood and appreciated that the subject disclosure is not limited by the order of acts, as some acts may occur in different order and/or concurrently with other acts from that shown and described herein. It is noted that not all illustrated acts may be required to implement a described method in accordance with the subject specification. In addition, for example, one or more methods disclosed herein could alternatively be represented as a series of interrelated states or events, such as in a state diagram. Moreover, interaction diagram(s) or call flow(s) represent several of the example methods disclosed herein in accordance with the described subject matter; particularly in instances when disparate entities, or functional elements, enact disparate portions of one or more of the several methods. Furthermore, two or more of the disclosed example methods can be implemented in combination, to accomplish one or more features or advantages described in the subject disclosure.

With reference to FIG. 6, illustrated is a flow chart of an example method 600 that can facilitate generating or selecting a financial offer (e.g., a preferred approved financial offer) and providing the financial offer to a communication device associated with a user (e.g., consumer), in accordance with various aspects and embodiments. The method 600 can be utilized, for example, by the open credit exchange platform (e.g., by a credit management component of the open credit exchange platform).

At 602, a set of approved financial offers from one or more financial service providers in relation to a consumer can be analyzed. The credit management component can analyze a set of approved financial offers that can be received from one or more financial service providers associated with the open credit exchange platform. The respective financial service providers can generate respective approved financial offers based at least in part on financial-related information (e.g., a set of N financial-related parameters) obtained from the open credit exchange platform, information relating to the consumer that is respectively known to the financial service providers, information relating to the consumer obtained from other information sources (e.g., the consumer, financial information provider(s), other information provider(s)), etc.

An approved financial offer can be an unconditional financial offer that only requires acceptance of the approved financial offer and execution of the contract relating to the approved financial offer. That is, the consumer is not required to submit an application (e.g., credit or loan application) and financial-related information associated with the consumer to the financial service provider to be considered for the approved financial offer presented to the consumer. The financial service provider has unconditionally pre-approved the consumer for the approved financial offer.

At 604, a preferred approved financial offer can be determined from the set of approved financial offers, based at least in part on the analyzing of the set of approved financial offers and the defined financial offer criteria, for presentation to a communication device (and/or a destination address) associated with the consumer. The credit management component can determine or identify the preferred (e.g., best, optimal, most preferred) approved financial offer from the set of approved financial offers in accordance with the defined financial offer criteria (and/or in accordance with application of corresponding defined financial offer rules). In some implementations, the credit management component also can determine or identify one or more other preferred (e.g., second most preferred, third most preferred, etc.) approved financial offers from the set of approved financial offers. The credit management component can communicate the preferred approved financial offer, or a notification relating to the preferred approved financial offer, to the communication device and/or a destination address (e.g., mobile phone number, email address, address associated with a social network site, etc.) associated with the consumer.

The consumer can review the preferred approved financial offer (or other preferred approved financial offer(s)) and can determine whether to accept the preferred approved financial offer (or other preferred approved financial offer(s)). If the consumer accepts, for example, the preferred approved financial offer, the consumer can execute (e.g., sign or electronically sign) an electronic contract document relating to the preferred approved financial offer, and can provide (e.g., transmit) the executed electronic contract document to the open credit exchange platform to facilitate completing the financial transaction.

The credit management component can verify the execution (e.g., signature or electronic signature) of the electronic contract document by the consumer, wherein the contract can be binding if the contract is verified, as more fully disclosed herein. The credit management component can notify financial service provider of the acceptance of the preferred approved financial offer (and previously can notify the financial service provider of the selection of the approved financial offer as the preferred offer). The credit management component can facilitate transferring monetary funds to an account of the consumer and/or applying monetary funds to a financial transaction (e.g., purchase of a car) relating to the preferred approved financial offer.

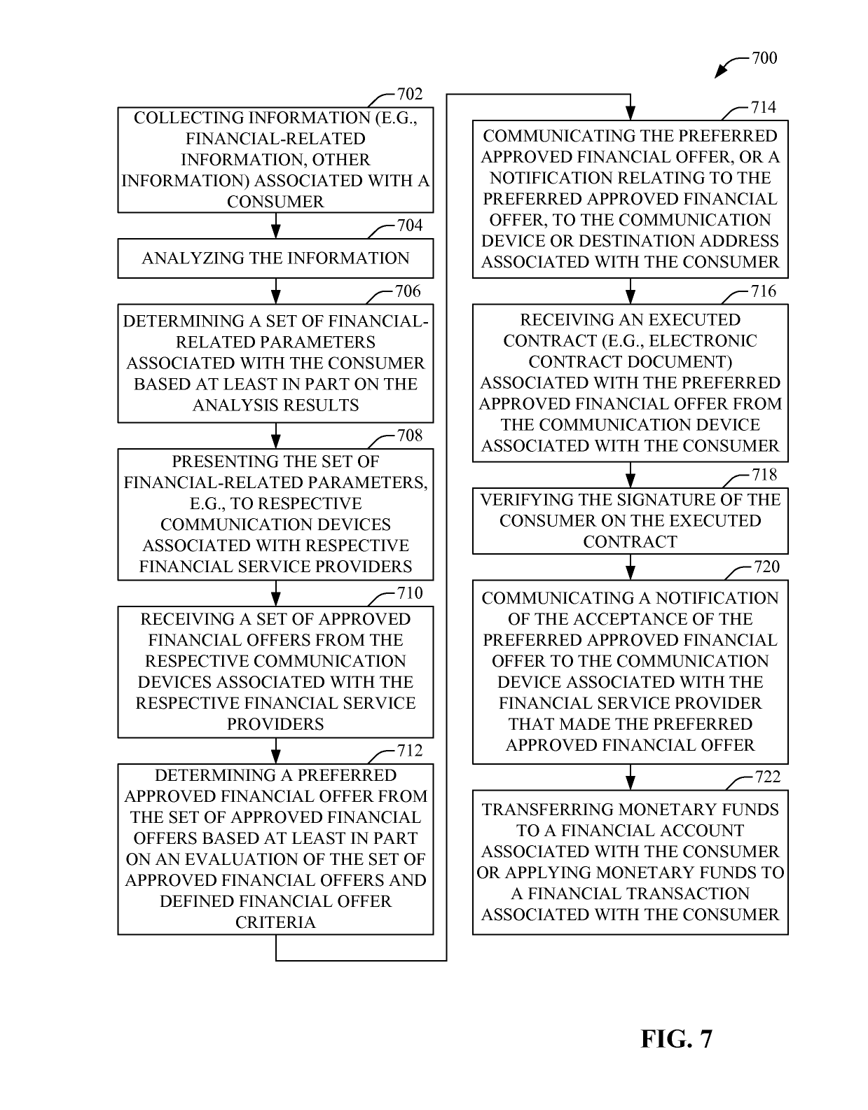

Referring to FIG. 7, depicted is a flow chart of another example method 700 that can facilitate generating or selecting a financial offer (e.g., a preferred approved financial offer) and providing the financial offer to a communication device associated with a user (e.g., consumer), in accordance with various aspects and embodiments. The method 700 can be utilized, for example, by the open credit exchange platform (e.g., by a credit management component of the open credit exchange platform.

At 702, information (e.g., financial-related information, other information) associated with a consumer can be collected. The credit management component can receive and collect information (e.g., financial-related information, demographic information, etc.) relating to the consumer. The credit management component can receive such information from the consumer, a financial service provider(s), a financial information provider(s), or another information provider(s), associated with the open credit exchange platform.

At 704, the information associated with the consumer can be analyzed. The credit management component can analyze such information associated with the consumer to facilitate determining a set (e.g., a number N) of financial-related parameters associated with the consumer. For example, the credit management component can analyze the information, and, based at least in part on the analysis, can standardize portions of the information, identify financial-related parameters, and/or can generate financial-related parameters to facilitate identifying or determining the set financial-related parameters associated with the consumer.

At 706, a set of financial-related parameters associated with the consumer can be determined based at least in part on the analysis results. The credit management component can determine or identify the set of financial-related parameters based at least in part on the analysis results.

At 708, the set of financial-related parameters can be presented, for example, to respective communication devices associated with respective financial service providers. The credit management component can present or make available the set of financial-related parameters associated with the consumer to the respective communication device of the respective financial service providers.

At 710, a set of approved financial offers can be received from the respective communication devices associated with the respective financial service providers. The respective financial service providers can utilize their respective communication devices to access the open credit exchange platform and the set of financial related parameters associated with the consumer. The FSP credit management components associated with the respective financial service providers can respectively identify approved financial offers based at least in part on the set of financial-related parameters, in accordance with their respective defined financial assessment criteria, as more fully disclosed herein. In some instances, the respective approved financial offers can relate to a particular financial transaction that the financial service providers are aware the consumer is contemplating. For example, the consumer can be at a car dealership contemplating purchasing a car, and the respective approved financial offers (e.g., respective car loan offers) can relate to the purchase of the car. The respective communication devices of the respective financial service providers can communicate respective approved financial offers, which can form the set of approved financial offers, to the open credit exchange platform.

At 712, a preferred approved financial offer can be determined from the set of approved financial offers based at least in part on an evaluation of the set of approved financial offers and defined financial offer criteria. The credit management component can evaluate the respective approved financial offers of the set of approved financial offers. Based at least in part on the results of that evaluation, the credit management component can determine or identify the preferred approved financial offer, in accordance with defined financial offer criteria and/or user preferences associated with the consumer, as more fully disclosed herein.

At 714, the preferred approved financial offer, or a notification relating to the preferred approved financial offer, can be communicated to the communication device or destination address associated with the consumer. The credit management component can communicate (e.g., transmit) the preferred approved financial offer, or the notification relating to the preferred approved financial offer, to the communication device or the destination address (e.g., mobile phone number, email address, social networking address, etc.) associated with the consumer. The preferred approved financial offer can be associated with an electronic contract document, which can be provided with the preferred approved financial offer or can be provided in response to acceptance of the preferred approved financial offer by the consumer.

At 716, an executed contract (e.g., electronic contract document) associated with the preferred approved financial offer can be received from the communication device associated with the consumer. The credit management component can receive the executed contract from the communication device (and/or origination address) associated with the consumer. If the consumer desires to accept the preferred approved financial offer, the consumer can execute (e.g., sign or electronically sign) the contract relating to the preferred approved financial offer, as more fully disclosed herein.

At 718, the signature of the consumer on the executed contract can be verified. The credit management component can analyze the signature (e.g., electronic signature) of the consumer on the executed contract to facilitate verification of the signature. For instance, the signature on the contract can be executed and secured based at least in part on a defined security protocol(s) (e.g., a defined cryptographic and/or authentication protocol(s)). The credit management component can determine whether the signature is valid or verified based at least in part on the defined security protocol(s).

At 720, a notification of the acceptance of the preferred approved financial offer can be communicated to the communication device associated with the financial service provider that made the preferred approved financial offer. The credit management component can generate the notification of the acceptance of the preferred approved financial offer to the communication device associated with the financial service provider. The credit management component can communicate such notification to the communication device associated with the financial service provider. The notification can include an electronic copy of the executed contract.

At 722, monetary funds can be transferred to a financial account associated with the consumer or applied to a financial transaction associated with the consumer. The credit management component can transfer monetary funds to the financial account associated with the consumer or apply the monetary funds to the financial transaction associated with the consumer. The credit management component can update financial-related information associated with the consumer based at least in part on the transfer of monetary funds to the financial account associated with the consumer or application of the monetary funds to the financial transaction associated with the consumer.

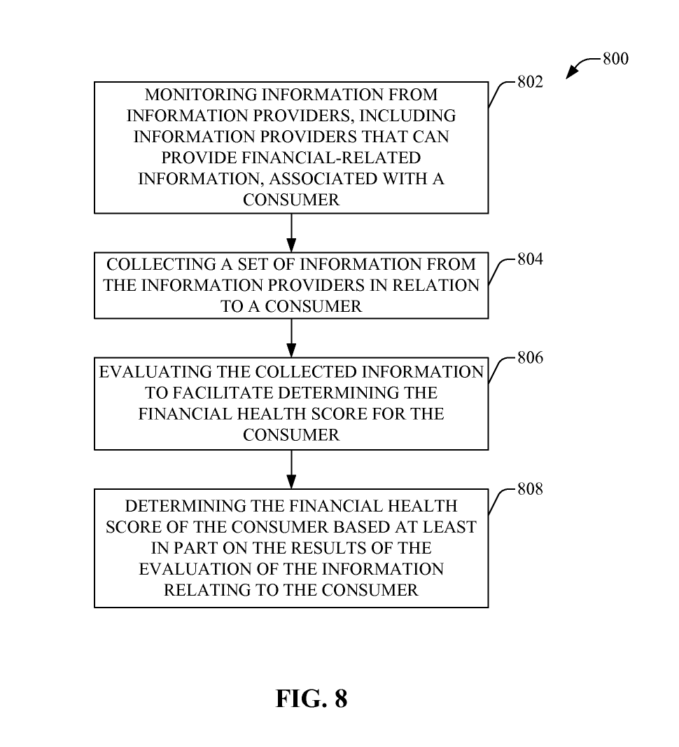

FIG. 8 presents a flow chart of an example method 800 for determining a financial health of a consumer, in accordance with various aspects and embodiments. The method 800 can be utilized, for example, by the open credit exchange platform (e.g., by a credit management component of the open credit exchange platform).

At 802, information from information providers (e.g., sources), including information providers that can provide financial-related information, associated with a consumer can be monitored. For a plurality of consumers, the credit management component of the open credit exchange platform can monitor information from various information providers. The various information providers can include consumers, financial service providers, financial information providers, and/or other information providers (e.g., information providers that can provide demographic information or other information).

At 804, a set of information can be collected from the information providers in relation to a consumer. The credit management component can collect or obtain the set of information (e.g., financial-related and/or other information) associated with the consumer. The credit management component can use the collected information to update information the credit management component already had for the consumer, use the collected information to create or update a user profile for the consumer, use the collected information for a snapshot analysis of the financial strength of the consumer, etc. The information can relate to, for example, income (e.g., current, historical, or projected income) of the consumer, debt (e.g., current, historical, or projected debt) of the consumer, bank account(s) of the consumer, credit account(s) of the consumer, loan balance(s) of the consumer, assets (e.g., monetary savings, real property, car, stocks, business, etc., assets or equity relating thereto), information relating a credit report or credit score of a financial information provider (e.g., a credit reporting agency), demographic information relating to the consumer, etc.

At 806, the collected information can be evaluated to facilitate determining the financial health score for the consumer. The credit management component can evaluate the collected information relating to the consumer to facilitate determining or identifying the financial health score of the consumer, in accordance with defined financial assessment criteria (e.g., defined financial health criteria). In accordance with the defined financial assessment criteria, the credit management component can apply respective weighting to respective items of information to facilitate identifying or generating the financial health score of the consumer. For example, in accordance with the defined financial assessment criteria, for the various types or items of information, the credit management component can apply a first weighting to a first type or item of information (e.g., a current income) associated with the consumer and a second weighting to a second type or item of information (e.g., an average salary of the consumer over a defined period of time).

At 808, the financial health score of the consumer can be determined based at least in part on the results of the evaluation of the information relating to the consumer. The credit management component can determine, identify, or generate the financial health score of the consumer based at least in part on the evaluation results and the defined financial assessment criteria. The financial health (or strength) score can have a standardized scoring range (e.g., 0 to 100, A (or AAA) to F, or another desired type of scoring range).

The credit management component can provide the financial health score to financial service providers associated with the open credit exchange platform to facilitate enabling financial service providers to assess the financial risk of making approved financial offers to the consumer. For example, the credit management component can provide or present N parameters to the financial service providers to facilitate enabling the financial service providers to assess the financial risk of making approved financial offers to the consumer, wherein the financial health score of the consumer can be one of the N parameters or a parameter of the N parameters can be based at least in part on the financial health score of the consumer. The credit management component also can provide the financial health score to the consumer to notify the consumer of the consumer's financial health score and/or as part of providing instruction to the consumer as to how the consumer can improve the consumer's financial health score. The credit management component also can use the financial health score of the consumer to facilitate mapping (e.g., real-time mapping) financial offers from the financial service providers to the consumer.

The open credit exchange platform also can be an always-on, always-updating platform. For instance, the credit management component can continue to monitor (e.g, automatically or dynamically monitor, monitor in real or near real time) information relating to consumers. The credit management component can update or modify (e.g., automatically, dynamically, or in real or near real time) the respective financial health scores of respective consumers based at least in part on evaluation of the monitored information, can store the updated or modified financial health scores of the respective consumers in respective user profiles of the consumers, and/or can make the updated or modified financial health scores of the respective consumers available to communication devices associated with the financial service providers and/or respective communication devices associated with the respective consumers.

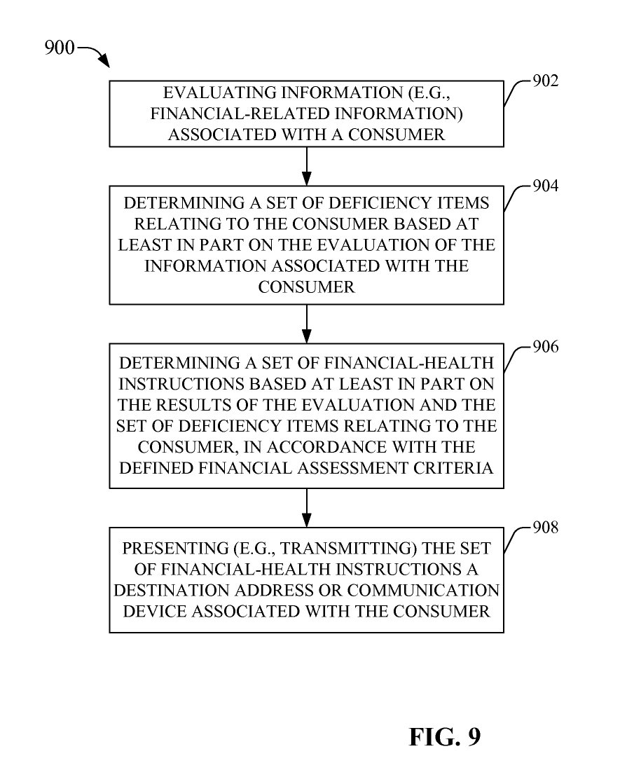

FIG. 9 illustrates a flow chart of an example method 900 for generating a set of financial-related instructions that can facilitate improving the financial health of a consumer, in accordance with various aspects and embodiments. The method 900 can be utilized, for example, by the open credit exchange platform (e.g., by a credit management component of the open credit exchange platform).

At 902, information (e.g., financial-related information) associated with the consumer can be evaluated. The credit management component can evaluate information (e.g., financial-related information) in a user profile of the consumer that is maintained by the credit management component, and can determine a financial health score of the consumer, in accordance with the defined financial risk criteria. The financial health score of the consumer can be determined based at least in part on the results of the evaluation of information (e.g., financial-related information) relating to the consumer. The credit management component can evaluate the information associated with the consumer, and determine or generate the financial health score of the consumer, for example, using aspects of the method 800 and/or as otherwise disclosed herein.

At 904, a set of deficiency items relating to the consumer can be determined based at least in part on the evaluation of the information associated with the consumer. The credit management component can determine or identify a set of deficiency items relating to the consumer based at least in part on the evaluation of the information associated with the consumer and/or the financial health score of the consumer. A deficiency item can be, for example, a low confidence level associated with a parameter (e.g., financial-related parameter) in relation to the consumer (e.g., a low confidence level in an income parameter associated with the consumer); a monthly debt-to-monthly income ratio that meets or exceeds a defined threshold ratio value; an overdue debt owed to a financial service provider that is showing in the financial-information associated with the consumer as remaining unpaid by the consumer; etc.

At 906, a set of financial-health instructions can be determined based at least in part on the results of the evaluation and the set of deficiency items relating to the consumer, in accordance with the defined financial assessment criteria. The credit management component can determine or identify the set of financial-health instructions based at least in part on the results of the evaluation and the set of deficiency items relating to the consumer.

For example, if the credit management component identifies that a confidence level associated with a parameter (e.g., financial-related parameter) for the consumer is low (e.g., below a defined threshold confidence level) based on a corresponding deficiency item (e.g., deficiency item that indicates a low confidence level associated with the parameter), the credit management component can determine that additional information relating to the parameter can facilitate improving the confidence level associated with that parameter and consequently the consumer's financial health score, and can generate a financial-health instruction that can facilitate instructing the consumer regarding how the consumer can improve the confidence level for that parameter and, as a result, the consumer's financial health score. For instance, based at least in part on the information evaluation, the credit management component can determine that the income parameter associated with the consumer is low due in part to the credit management component not having current income information associated with the consumer (e.g., the credit management component has income information (e.g., in the user profile) for the consumer from 4 years ago in relation to a home mortgage application of the consumer, but no information showing the consumer's current income). Based at least in part on the confidence level associated with the income parameter being low and the income information in the user profile, the credit management component can determine that additional information (e.g., current information) relating to the income of the consumer can facilitate improving the confidence level associated with the income parameter and consequently the financial score of the consumer. In response, the credit management component can generate a financial-health instruction that can facilitate instructing the consumer regarding how the consumer can improve the confidence level for the income parameter and, as a result, improve the consumer's financial health score. For example, the financial-health instruction can instruct the consumer to provide current income information (e.g., copies of the last two paycheck stubs of the consumer, a copy of the most recent paystub showing year-to-date income of the consumer, and/or a copy of the most recent W-2 form or income tax return of the consumer) to the open credit exchange platform to facilitate improving (e.g., increasing) the confidence level in the income parameter associated with the consumer and thereby improve the financial health score of the consumer.

As another example, the credit management component can identify that an overdue debt owed (or allegedly) owed by the consumer to a financial service provider is still showing as active (e.g., unpaid, unresolved) in the financial-related information associated with the consumer. The credit management component can determine that a financial-health instruction that instructs the consumer to pay the overdue debt or otherwise resolve the overdue-debt item (e.g., work out an agreement with the financial service provider to pay a portion of the debt in compromise to close out the debt, contact the financial service provider to correct the financial record of the consumer if the overdue-debt item is in error, etc.) can facilitate improving the financial health score of the consumer.

As still another example, if the credit management component determines that the consumer is carrying relatively high monthly debt obligations in relation to the consumer's income (e.g., the debt-to-income ratio of the consumer meets or exceeds a defined threshold ratio) and determines that the consumer is eligible to refinance certain debt, which can lower the monthly debt obligations of the consumer and lower the debt-to-income ratio of the consumer below the defined threshold ratio, and thereby improve the financial health score of the consumer, the credit management component can determine that an instruction to refinance the certain debt can facilitate improving the financial health score of the consumer.

At 908, the set of financial-health instructions can be presented (e.g., transmitted) a destination address or communication device associated with the consumer. The credit management component can transmit the set of financial-health instructions, and/or a related notification that can notify the consumer that the set of financial-health instructions are available to the consumer, to a destination address (e.g., phone number, email address, social networking address or message box address, etc.) and/or communication device (e.g., mobile phone) associated with the consumer. The consumer can utilize the set of financial-health instructions as desired by the consumer.

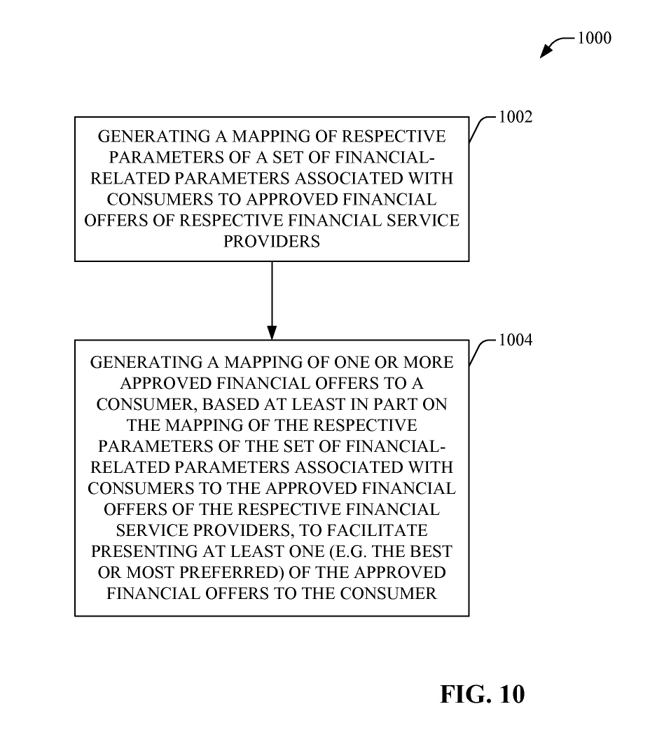

FIG. 10 depicts a flow chart of an example method 1000 for generating a mapping to facilitate mapping approved financial offers to consumers, in accordance with various aspects and embodiments. The method 1000 can be utilized, for example, by the open credit exchange platform (e.g., by a credit management component of the open credit exchange platform).

At 1002, a mapping of respective parameters of a set (e.g., N) of financial-related parameters associated with consumers to approved financial offers of respective financial service providers can be generated. The credit management component can generate (e.g., in real or near real time) the mapping of the respective parameters of the set of financial-related parameters associated with consumers to the approved financial offers of the respective financial service providers. The credit management component can generate or update the mapping in real time, or at least near real time, in relation to real time, or at least near real time, approved financial offers of the respective financial service providers and/or the real time, or at least near real time, current or updated financial-related information (e.g. as identified in the respective set of financial-related parameters) associated with the respective consumers. The open credit exchange platform can receive an approved financial offer from a financial service provider in real or near real time, or an approved financial offer from a financial service provider can be a previously existing offer that can be correlated to the set of financial-related parameters.

At 1004, a mapping of one or more approved financial offers to a consumer can be generated, based at least in part on the mapping of the respective parameters of the set of financial-related parameters associated with consumers, including the consumer, to the approved financial offers of the respective financial service providers, to facilitate presenting at least one (e.g. the best or most preferred) of the approved financial offers to the consumer. For each consumer associated with the open credit exchange platform, the credit management component can generate (e.g., in real or near real time) the mapping of the one or more approved financial offers to the consumer. It is to be appreciated and understood that the respective mappings generated at operation 1002 and operation 1004 can form (e.g., can be joined together to form) a more comprehensive mapping.

For instance, for each consumer, the credit management component can identify a probabilistic or identified amount of money (e.g., bag of money) that the consumer can have available to spend based at least in part on current assets (e.g., liquid assets, such as monetary funds on hand to the consumer) and the financial strength of the consumer, and/or other factors (e.g., in accordance with applicable financial assessment criteria). The credit management component can map the probabilistic or identified amount of money of the consumer to one or more approved financial offers of respective financial service providers to facilitate presenting at least one (e.g. the best or most preferred) of the approved financial offers to the consumer.

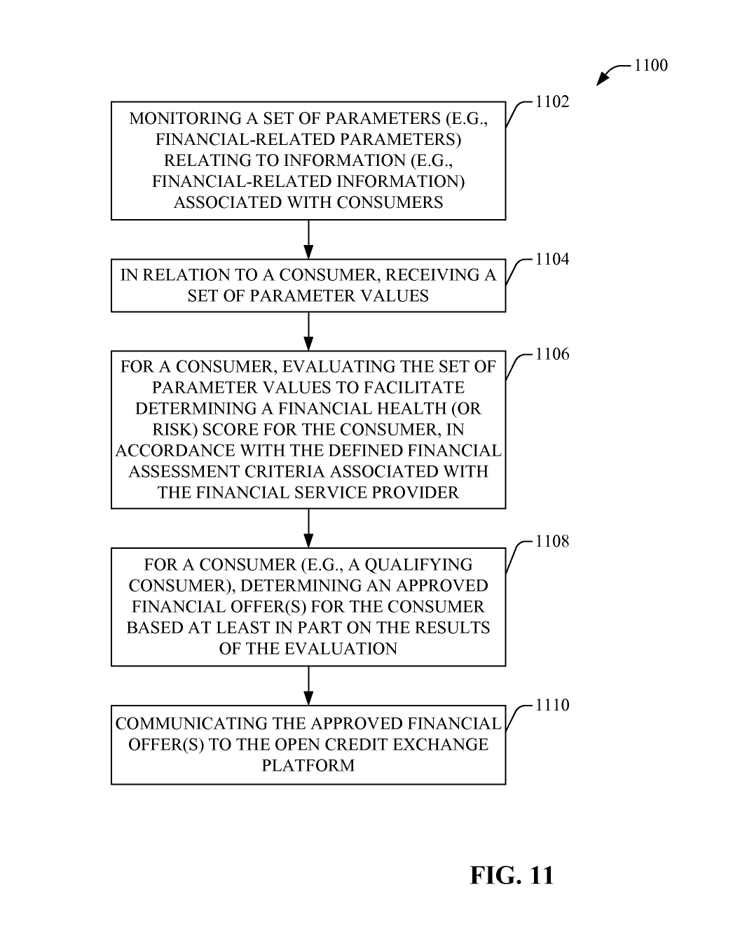

FIG. 11 depicts a flow chart of an example method 1100 for determining an approved financial offer that can be presented to a consumer, in accordance with various aspects and embodiments. The method 1100 can be employed, for example, by an FSP credit management component associated with a financial service provider associated with the open credit exchange platform. There can be a plurality of FSP credit management components respectively associated with a plurality of financial service providers that can be associated with the open credit exchange platform.

At 1102, a set of parameters (e.g., financial-related parameters) relating to information (e.g., financial-related information) associated with consumers can be monitored. An FSP credit management component associated with a financial service provider can be associated with (e.g., registered with and/or communicatively connected to) the open credit exchange platform. The FSP credit management component can monitor the set of parameters (e.g., a set of N parameters), wherein, for respective consumers, there can be respective sets of parameter values for the set of parameters. The parameters can be, for example, financial-related parameters (e.g., current income of consumer, outstanding debt of consumer, financial health score of consumer, and/or credit score of consumer, etc.), as more fully disclosed herein.

At 1104, in relation to a consumer (e.g., for all or some consumers associated with the open credit exchange platform), a set of parameter values can be received (e.g., obtained). The FSP credit management component can receive a set of parameter values associated with a consumer that can respectively correspond to the set of parameters from the open credit exchange platform.

At 1106, for a consumer, the set of parameter values can be evaluated to facilitate identifying a financial health (or risk) score for the consumer, in accordance with the defined financial assessment criteria associated with the financial service provider. The FSP credit management component can evaluate the set of parameter values (associated with a set (e.g., N) of parameters) for a consumer to facilitate determining whether an approved financial offer is to be presented to the consumer and/or the terms of the approved financial offer that is to be presented to the consumer, in accordance with the defined financial assessment criteria (e.g., defined financial risk criteria) associated with the financial service provider. In accordance with the defined financial assessment criteria, the FSP credit management component can apply respective weighting to respective parameters of the set of financial parameters to facilitate determining whether an approved financial offer is to be presented to the consumer and/or determining the terms of the approved financial offer that is to be presented to the consumer. For example, in accordance with the defined financial assessment criteria associated with the financial service provider, the FSP credit management component can apply a first weighting to a first parameter value (e.g., a current debt-to-income ratio) associated with the consumer and a second weighting to a second parameter value (e.g., a current total amount of assets, or a net worth) associated with the consumer. In accordance with various implementations, the FSP credit management component can determine its own financial health or risk score for a consumer, and/or can utilize the financial health score for the consumer as determined by the open credit exchange platform, and/or can apply respective weightings to the financial health or risk score determined by the FSP credit management component and the financial health score obtained from the open credit exchange platform, in accordance with the defined financial assessment criteria.

As desired, in accordance with the defined financial assessment criteria, a financial service provider can apply a higher weighting to a parameter value(s) and/or other financial-related information relating to a financial transaction(s) (e.g., loan, credit line, etc.) between the financial service provider and the consumer than a weighting applied to another parameter value(s) or other financial information associated with the consumer that does not relate, or at least directly relate, to the relationship between the financial service provider and the consumer. For example, the financial service provider can apply a higher weighting to a parameter value or financial-related information relating to a payment or credit history the consumer has with the financial service provider than a weighting applied to another parameter value or other information relating to a payment or credit history the consumer has with other financial service providers.

At 1108, for a consumer (e.g., a qualifying consumer, in accordance with the defined financial assessment criteria associated with the financial service provider), an approved financial offer(s) for the consumer can be determined based at least in part on the results of the evaluation. The FSP credit management component can determine or identify one or more approved financial offers (e.g., different financial offers with different financial terms) for the consumer that can be provided to the open credit exchange platform to facilitate presentation of the one or more approved financial offers to the consumer (e.g., the qualifying consumer), based at least in part on the evaluation results and the defined financial assessment criteria. In some implementations, the FSP credit management component can generate an electronic contract document associated with an approved financial offer, and the FSP credit management component can include the electronic contract document with such offer or can provide the electronic contract document to the open credit exchange platform or consumer in response to acceptance of the approved financial offer.

At 1110, the approved financial offer(s) can be communicated (e.g., transmitted) to the open credit exchange platform. The FSP credit management component can communicate the approved financial offer(s) to the open credit exchange platform, wherein the open credit exchange platform can process the approved financial offer(s) (e.g., to facilitate determining whether to present the approved financial offer(s) to the consumer, for example, as a preferred approved financial offer(s)).

It is to be appreciated and understood that, in accordance with various implementations, the method 1100 can be agnostic with regard to particular consumers. That is, the FSP credit management component can employ the method 1100 to determine and generate an approved financial offer (e.g., a generic approved financial offer) that is not necessarily directed to any particular consumer, and instead can be directed to any consumer that meets or exceeds a qualifying (e.g., threshold) financial health or risk score. For example, the FSP credit management component can determine and generate a generic approved financial offer that the FSP credit management component can authorize the open credit exchange platform to extend to any consumer that can meet the financial health or risk score associated with (e.g., assigned to) the approved financial offer (e.g., the generic approved financial offer can be extended to any consumer that has a financial health score that meets or exceeds a defined threshold financial health score).

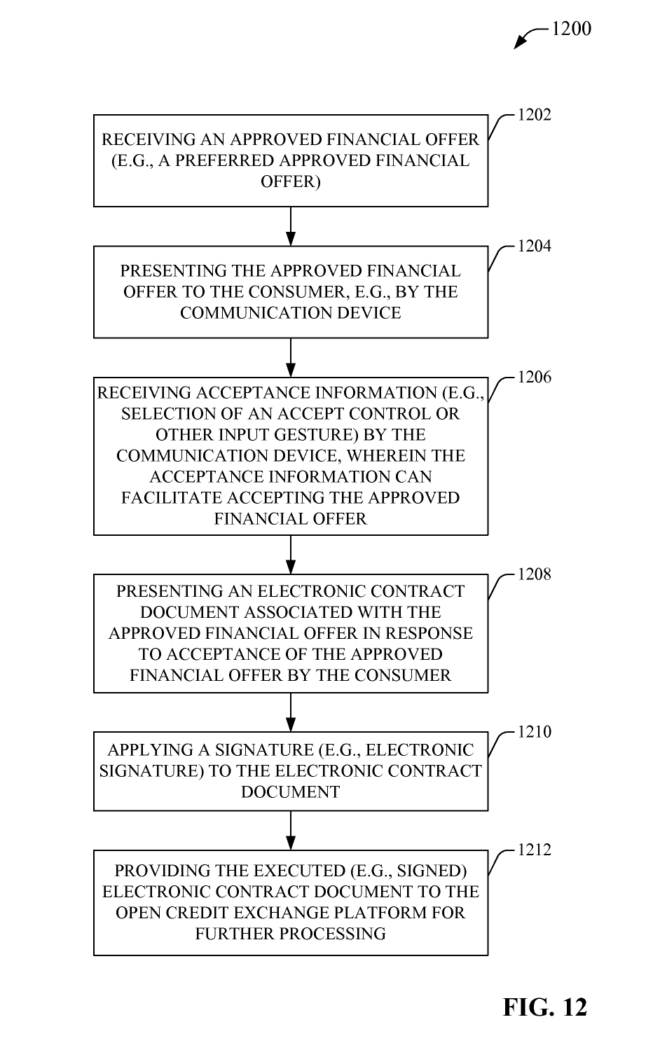

FIG. 12 presents a flow chart of an example method 1200 that can facilitate accepting an approved financial offer and signing an electronic contract document associated with the approved financial offer via a communication device associated with a consumer in accordance with various aspects and embodiments. The method 1200 can be employed, for example, by a communication device associated with the consumer, wherein the communication device can include a consumer finances management component.

At 1202, an approved financial offer (e.g., a preferred approved financial offer) can be received. The communication device can receive the approved financial offer from the open credit exchange platform. The approved financial offer can be received in relation to a potential or pending financial transaction (e.g., purchase of a car, a home, or other product or service) associated with the consumer or can be received without regard to a particular financial transaction.

At 1204, the approved financial offer can be presented (e.g., displayed) to the consumer, for example, by the communication device. The consumer finances management component of the communication device can facilitate presenting the approved financial offer to the consumer via a display on the communication device.

At 1206, acceptance information (e.g., selection of an accept control or other input gesture) can be received by the communication device, wherein the acceptance information can facilitate accepting the approved financial offer. The communication device, utilizing the consumer finances management component, can receive acceptance information via an interface (e.g., GUI or touch-screen GUI, keyboard, voice interface, etc.) that can facilitate indicating acceptance of the approved financial offer by the consumer.

At 1208, an electronic contract document associated with the approved financial offer can be presented in response to acceptance of the approved financial offer by the consumer. The consumer finances management component can facilitate presenting the electronic contract document to the consumer via an interface (e.g., display) of the communication device, wherein the electronic contract document can be a contract provided by the financial service provider in relation to the approved financial offer. The electronic contract document can be received by, or presented to, the communication device from, or by, the open credit exchange platform with the approved financial offer, or can be received by, or presented to, the communication device from, or by, the open credit exchange platform or the FSP credit management component associated with the financial service provider in response to receiving the acceptance information indicating acceptance of the approved financial offer by the consumer.

At 1210, a signature (e.g., electronic signature) can be applied to the electronic contract document. The consumer finances management component can receive signature information from the consumer via an interface of the communication device. The signature information can include, for example, a signature (e.g., a typed signature, written signature, a code or other mark that can represent a signature) of the consumer and/or authentication information that can facilitate verifying the signature of the consumer. The consumer finances management component can apply the signature to the electronic contract document and can secure and verify the signature on the electronic contract document based at least in part on the authentication information (e.g., validated authentication information). For example, in response to receiving valid authentication information from the consumer, the consumer finances management component can verify the signature of the consumer on the electronic contract document and/or can encrypt the signature to facilitate securing the signature on the electronic contract document.

At 1212, the executed (e.g., signed) electronic contract document can be provided (e.g., transmitted or presented) to the open credit exchange platform for further processing (e.g., for validation of the electronic contract document by the open credit exchange platform and facilitating the financial transaction (e.g., transfer of monetary funds) associated with the approved financial offer.

Additionally or alternatively, the electronic contract document can reside at the open credit exchange platform, and the consumer finances management component can transmit the signature information (e.g., signature and/or authentication information) associated with the consumer to the credit management component of the open credit exchange platform. The credit management component can receive the signature information from the consumer finances management component. The credit management component can apply the signature to the electronic contract document and can secure and verify the signature on the electronic contract document based at least in part on the authentication information (e.g., validated authentication information) provided by the consumer. For example, in response to receiving valid authentication information from the consumer, the credit management component can verify the signature of the consumer on the electronic contract document and/or can encrypt the signature to facilitate securing the signature on the electronic contract document, wherein an executed electronic contract document (e.g., an electronic contract document that is signed by the consumer, or signed by the consumer and the financial service provider or other authorized agent) that is verified by the credit management component can be a binding legal contract. If the credit management component (and/or the consumer finances management component) determine that the signature of the consumer is not valid and/or the authentication information provided by the consumer is not valid, the credit management component (and/or the consumer finances management component) can determine that the electronic contract document is not properly executed and a legal binding contract has not yet been created.

In some implementations, the credit management component (and/or the consumer finances management component) can allow the consumer to attempt to validly sign the electronic contract document up to a defined threshold number of contract execution attempts. If the consumer fails to provide a valid signature and/or authentication information after a number of attempts that is equal to the defined threshold number of contract execution attempts, the credit management component (and/or the consumer finances management component) can determine that the electronic contract document is not properly signed and is not a legal binding contract. The credit management component (and/or the consumer finances management component) also can perform one or more other response actions in response to determining that the consumer failed to provide a valid signature and/or authentication information after a number of attempts that is equal to the defined threshold number of contract execution attempts.

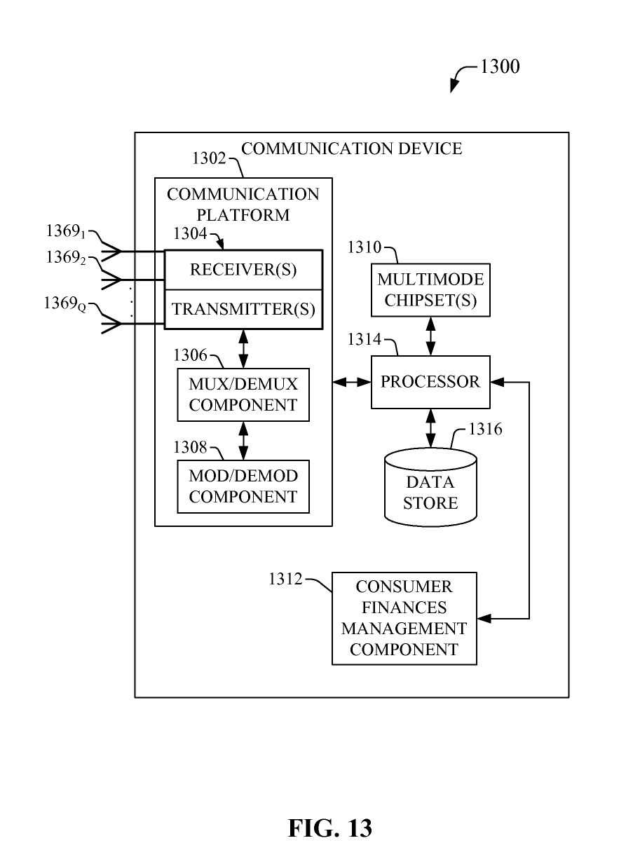

FIG. 13 depicts a block diagram of an example wireless communication device 1300 in accordance with various aspects and embodiments of the disclosed subject matter. In an aspect, the communication device 1300 can be a multimode access terminal, wherein a set of antennas 1369₁-1369_{Q} (Q is a positive integer) can receive and transmit signal(s) from and to wireless devices like access points, access terminals, wireless ports and routers, and so forth, that operate in a radio access network. It should be appreciated that antennas 1369₁-1369_{Q} are a part of communication platform 1302, which comprises electronic components and associated circuitry that provide for processing and manipulation of received signal(s) and signal(s) to be transmitted; e.g., receivers and transmitters 1304, multiplexer/demultiplexer (mux/demux) component 1306, and modulation/demodulation (mod/demod) component 1308.

In another aspect, the communication device 1300 can include a multimode operation chipset(s) 1310 that can allow the communication device 1300 to operate in multiple communication modes in accordance with disparate technical specification for wireless technologies. In an aspect, multimode operation chipset(s) 1310 can utilize communication platform 1302 in accordance with a specific mode of operation (e.g., voice, GPS). In another aspect, multimode operation chipset(s) 1310 can be scheduled to operate concurrently (e.g., when Q>1) in various modes or within a multitask paradigm.

In still another aspect, the communication device 1300 can comprise a consumer finances management component 1312 that can be used to facilitate receiving, reviewing, and/or accepting offers (e.g., approved financial offers) from the open credit exchange program, execute electronic contract documents relating to an approved financial offer, manage a digital wallet and/or finances (e.g., pay debts, transfer monetary funds between accounts, etc.) associated with a consumer, etc., as more fully described herein. The consumer finances management component 1312 can be installed on the communication device 1300 by installing an application, for example.

In still another aspect, the communication device 1300 also can include a processor(s) 1314 that can be configured to confer functionality, at least in part, to substantially any electronic component within the communication device 1300, in accordance with aspects of the disclosed subject matter. For example, the processor(s) 1314 can facilitate enabling the communication device 1300 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. As another example, the processor(s) 1314 can facilitate enabling the communication device 1300 to process data relating to managing a digital wallet associated with the consumer, managing finances associated with the consumer, approved financial offers, executing electronic contract documents relating to an approved financial offer, authentication of the consumer or another entity, securing data (e.g., cryptographically securing data) and/or other data processes relating to processing information, including processing financial-related information.

The communication device 1300 also can contain a data store 1316 that can store data structures (e.g., user data, metadata); code structure(s) (e.g., modules, objects, classes, procedures) or instructions; message hashes; information relating to managing a digital wallet associated with the consumer, managing finances associated with the consumer, approved financial offers, executing electronic contract documents relating to an approved financial offer, authentication of the consumer or another entity, securing data, etc.; network or device information like policies and specifications; attachment protocols; code sequences for scrambling, spreading and pilot (e.g., reference signal(s)) transmission; frequency offsets; cell IDs; encoding algorithms; compression algorithms; decoding algorithms; decompression algorithms; and so on. In an aspect, the processor(s) 1314 can be functionally coupled (e.g., through a memory bus) to the data store 1316 in order to store and retrieve information (e.g., information relating to mobile messaging, voice calls, or other services; frequency offsets; desired algorithms; information relating to managing a digital wallet associated with the consumer, managing finances associated with the consumer, approved financial offers, executing electronic contract documents relating to an approved financial offer, authentication of the consumer or another entity, or securing data; etc.) desired to operate and/or confer functionality, at least in part, to the communication platform 1302, multimode operation chipset(s) 1310, consumer finances management component 1312, and/or substantially any other operational aspects of the communication device 1300.

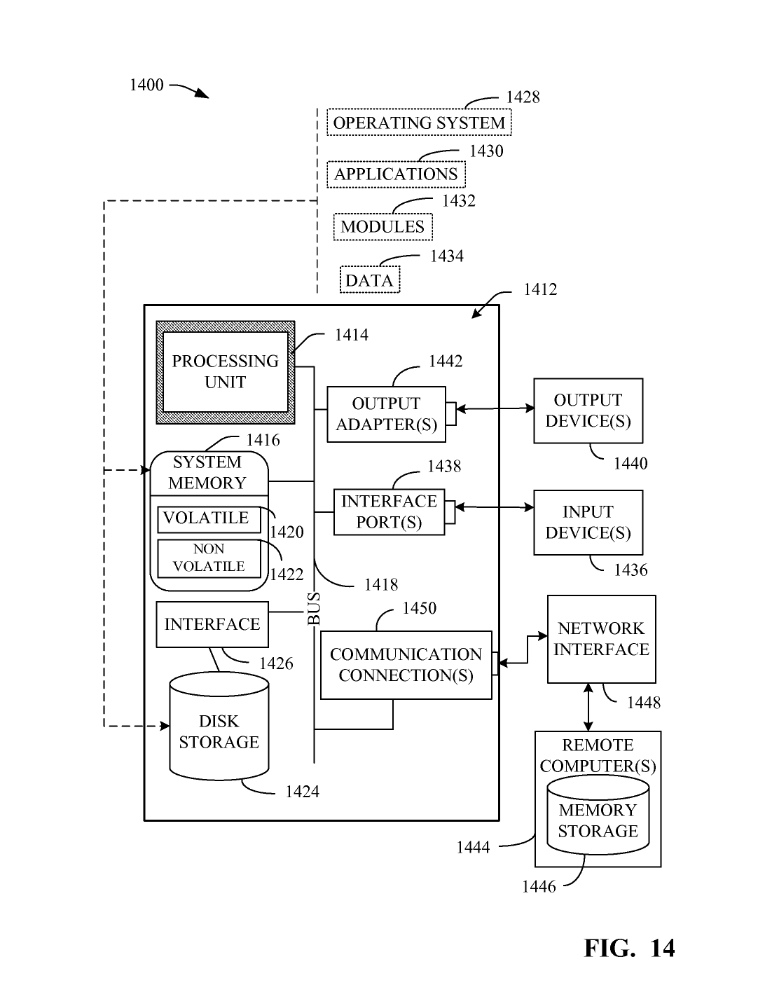

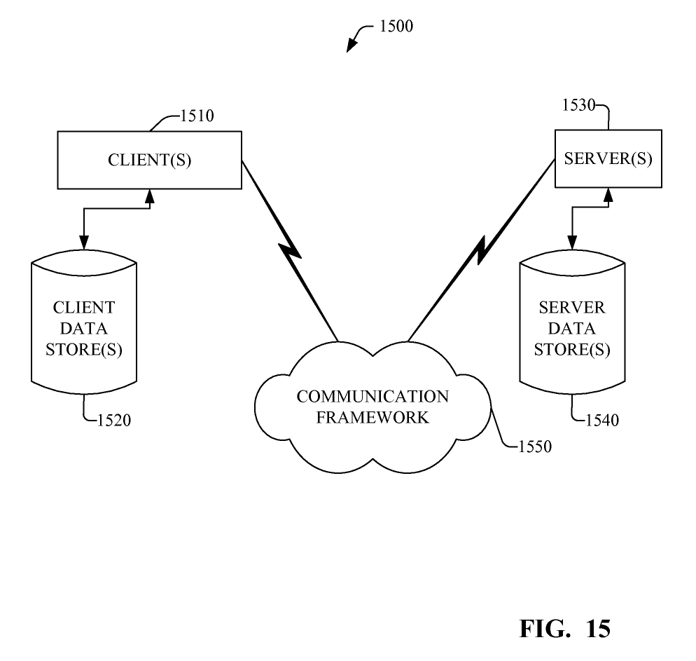

In order to provide a context for the various aspects of the disclosed subject matter, FIGS. 14 and 15 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the disclosed subject matter also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of the disclosed subject matter can be practiced on stand-alone computers. In a distributed computing environment, program modules may be located in both local and remote memory storage devices.

In accordance with various aspects and embodiments, the computer (e.g., 1412) can be, for example, a communication device that can be associated with an open credit exchange platform and can comprise, be associated with, and/or implement various aspects and/or functions of the open credit exchange platform; a communication device that can be associated with a financial service provider and can comprise, be associated with, and/or implement various aspects and/or functions of an FSP credit management component; or a communication device that can be associated with a consumer and can comprise, be associated with, and/or implement various aspects and/or functions of the consumer finances management component.

With reference to FIG. 14, a suitable environment 1400 for implementing various aspects of the disclosed subject matter includes a computer 1412. The computer 1412 includes a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414.

The system bus 1418 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1412 also includes removable/non-removable, volatile/nonvolatile computer storage media. FIG. 14 illustrates, for example, a disk storage 1424. Disk storage 1424 includes, but is not limited to, devices like a magnetic disk drive, floppy disk drive, tape drive, Jaz drive, Zip drive, LS-100 drive, flash memory card, or memory stick. In addition, disk storage 1424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to the system bus 1418, a removable or non-removable interface is typically used, such as interface 1426.

It is to be appreciated that FIG. 14 describes software that acts as an intermediary between users and the basic computer resources described in the suitable operating environment 1400. Such software includes an operating system 1428. Operating system 1428, which can be stored on disk storage 1424, acts to control and allocate resources of the computer system 1412. System applications 1430 take advantage of the management of resources by operating system 1428 through program modules 1432 and program data 1434 stored either in system memory 1416 or on disk storage 1424. It is to be appreciated that the claimed subject matter can be implemented with various operating systems or combinations of operating systems.

A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port may be used to provide input to computer 1412, and to output information from computer 1412 to an output device 1440. Output adapter 1442 is provided to illustrate that there are some output devices 1440 like monitors, speakers, and printers, among other output devices 1440, which require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a personal computer, a server, a router, a network PC, a workstation, a microprocessor based appliance, a peer device or other common network node and the like, and typically includes many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1450 refers to the hardware/software employed to connect the network interface 1448 to the bus 1418. While communication connection 1450 is shown for illustrative clarity inside computer 1412, it can also be external to computer 1412. The hardware/software necessary for connection to the network interface 1448 includes, for exemplary purposes only, internal and external technologies such as, modems including regular telephone grade modems, cable modems and DSL modems, ISDN adapters, and Ethernet cards.

FIG. 15 is a schematic block diagram of a sample-computing environment 1500 with which the subject specification can interact. The system 1500 includes one or more client(s) 1510. The client(s) 1510 can be hardware and/or software (e.g., threads, processes, computing devices). The system 1500 also includes one or more server(s) 1530. Thus, system 1500 can correspond to a two-tier client server model or a multi-tier model (e.g., client, middle tier server, data server), amongst other models. The server(s) 1530 can also be hardware and/or software (e.g., threads, processes, computing devices). The servers 1530 can house threads to perform transformations by employing the disclosed subject matter, for example. One possible communication between a client 1510 and a server 1530 may be in the form of a data packet transmitted between two or more computer processes.

The system 1500 includes a communication framework 1550 that can be employed to facilitate communications between the client(s) 1510 and the server(s) 1530. The client(s) 1510 are operatively connected to one or more client data store(s) 1520 that can be employed to store information local to the client(s) 1510. Similarly, the server(s) 1530 are operatively connected to one or more server data store(s) 1540 that can be employed to store information local to the servers 1530.

It is to be appreciated and understood that components (e.g., open credit exchange platform, credit management component, communication device, FSP credit management component, consumer finances management component, communication network, etc.), as described with regard to a particular system or method, can include the same or similar functionality as respective components (e.g., respectively named components or similarly named components) as described with regard to other systems or methods disclosed herein.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “mobile station,” “mobile,” “wireless device,” “wireless communication device,” “access terminal,” “terminal,” and similar terminology are used herein to refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the term “access point” (AP), can be or can comprise a base station, Node B, Evolved Node B (eNode B or eNB), Home Node B (HNB), home access point (HAP), and can refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be noted that aspects, features, and/or advantages of the disclosed subject matter can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and flash memory devices (e.g., card, stick, key drive, etc.), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory to store computer-executable components; and
a processor, coupled to the memory, that executes or facilitates execution of at least one of the computer-executable components, the computer-executable components comprising:
an open credit exchange component that is associated with a set of financial service provider identities and a set of consumer identities, and facilitates presentation of a preferred approved financial offer to a communication device determined to be associated with a consumer identity of the set of consumer identities; and
a credit management component that determines the preferred approved financial offer, based on at least in part on an analysis of a set of approved financial offers received from one or more financial service provider identities of the set of financial service provider identities and a defined financial offer criterion with respect to a pre-computed financial health score associated with the consumer identity, to facilitate the presentation of the preferred approved financial offer to the communication device associated with the consumer identity.

2. The system of claim 1, wherein the credit management component collects respective financial-related information associated with respective consumer identities, including the consumer identity, of the set of consumer identities and generates a set of financial-related parameters associated with the set of consumer identities based at least in part on the respective financial-related information, wherein respective financial-related parameters of the set of financial-related parameters have respective parameter values in relation to the respective consumer identities based at least in part on the respective financial-related information associated with the respective consumer identities.

3. The system of claim 2, wherein the credit management component presents the set of financial-related parameters associated with the set of consumer identities to respective financial service provider (FSP) credit management components associated with respective financial service provider identities of the set of financial service provider identities to facilitate generation of approved financial offers of the set of approved financial offers.

4. The system of claim 3, wherein the credit management component controls an amount or a type of financial-related information associated with the consumer identity that is exposed to the set of financial service provider identities based at least in part on preferences associated with the consumer identity.

5. The system of claim 2, wherein the credit management component determines respective financial health scores associated with the respective consumer identities based at least in part on the respective financial-related information associated with the respective consumer identities and a defined financial assessment criterion.

6. The system of claim 5, wherein the credit management component monitors the financial-related information associated with the consumer identity at least one of continuously, periodically, or in response to an occurrence of a financial event associated with the consumer identity, collects updated financial-related information associated with the consumer identity in response to the monitoring, and updates the financial health score associated with the consumer identity in response to the updated financial-related information associated with the consumer identity.

7. The system of claim 2, wherein the credit management component analyzes the financial-related information associated with the consumer identity, identifies a set of deficiency items associated with the financial-related information based at least in part on the analysis of the financial-related information, determines a set of financial-health instructions that facilitates improvement of a financial health score associated with the consumer identity based at least in part on the set of deficiency items, and presents the set of financial-health instructions to the communication device associated with the consumer identity.

8. The system of claim 2, wherein the credit management component generates a mapping of respective approved financial offers of the set of approved financial offers to the respective consumer identities, based at least in part on the respective financial-related information associated with the respective consumer identities, to facilitate a determination of the set of approved financial offers in relation to the consumer identity.

9. The system of claim 1, wherein the credit management component generates a notification associated with the preferred approved financial offer, and transmits the notification to the communication device associated with the consumer identity to facilitate notifying the consumer identity of availability of the preferred approved financial offer.

10. The system of claim 1, wherein the credit management component receives an acceptance indicator from the communication device associated with the consumer identity, and the acceptance indicator indicates that the consumer identity has accepted the preferred approved financial offer.

11. The system of claim 10, wherein the credit management component presents an electronic contract document relating to the preferred approved financial offer to the communication device associated with the consumer identity as part of the presentation of the preferred approved financial offer to the communication device or in response to the receipt of the acceptance indicator.

12. The system of claim 11, wherein the credit management component analyzes a signed electronic contract document, which is the electronic contract document that has been electronically signed by the consumer identity, and determines whether an electronic signature of the consumer identity associated with the signed electronic contract document is verified based at least in part on results of analysis of the electronic signature of the consumer identity and authentication information associated with the electronic signature.

13. The system of claim 12, wherein the credit management component facilitates performing a financial transaction associated with the preferred approved financial offer in response to a determination that the electronic signature of the consumer identity is verified.

14. A method, comprising:
analyzing, by a system comprising a processor, a set of approved financial offers received from one or more financial service provider identities in relation to a consumer identity; and
determining, by the system, a highest-rated approved financial offer from the set of approved financial offers, based at least in part on results of the analyzing of the set of approved financial offers and a financial offer criterion defined as a function of a real-time financial health score associated with the consumer identity, to facilitate presenting the highest-rated approved financial offer to a communication device associated with the consumer identity.

15. The method of claim 14, further comprising:
receiving, by the system, respective financial-related information associated with respective consumer identities, including the consumer identity, of the set of consumer identities;
analyzing, by the system, the respective financial-related information; and
generating, by the system, a set of financial-related parameters associated with the set of consumer identities, wherein respective financial-related parameters of the set of financial-related parameters have respective parameter values in relation to the respective consumer identities based at least in part on results of the analyzing of the respective financial-related information associated with the respective consumer identities.

16. The method of claim 15, further comprising:
presenting, by the system, the set of financial-related parameters associated with the set of consumer identities to respective financial service provider (FSP) credit management components associated with respective financial service provider identities of the one or more financial service provider identities to facilitate generating approved financial offers for the set of approved financial offers.

17. The method of claim 16, further comprising:
controlling, by the system, an amount or a type of financial-related information associated with the consumer identity that is exposed to the set of financial service provider identities based at least in part on preferences associated with the consumer identity.

18. The method of claim 15, further comprising:
determining, by the system, respective financial health scores associated with the respective consumer identities based at least in part on results of the analyzing of the respective financial-related information associated with the respective consumer identities and a financial assessment criterion.

19. The method of claim 18, further comprising:
monitoring, by the system, the financial-related information associated with the consumer identity at least one of continuously, periodically, or in response to an occurrence of a financial event associated with the consumer identity, in an always-on operating environment that facilitates updating the respective financial health scores associated with the respective consumer identities in real time;
in the always-on operating environment, receiving, by the system, updated financial-related information associated with the consumer identity in response to the monitoring; and
in the always-on operating environment, updating, by the system, the real-time financial health score associated with the consumer identity in response to the updated financial-related information associated with the consumer identity.

20. The method of claim 15, further comprising:
determining, by the system, a set of deficiency items associated with the financial-related information associated with the consumer identity based at least in part on results of the analyzing of the financial-related information associated with the consumer identity;
determining, by the system, a set of financial-health instructions that facilitates enhancement of a financial health score associated with the consumer identity in response to the determining of the set of deficiency items; and
transmitting, by the system, the set of financial-health instructions to the communication device associated with the consumer identity.

21. The method of claim 14, further comprising:
generating, by the system, a notification associated with the highest-rated approved financial offer; and
transmitting, by the system, the notification to the communication device associated with the consumer to facilitate notifying the consumer identity of availability of the highest-rated approved financial offer.

22. The method of claim 14, further comprising:
receiving, by the system, an acceptance indicator from the communication device associated with the consumer identity, wherein the acceptance indicator indicates that the consumer identity is accepting the highest-rated approved financial offer.

23. The method of claim 22, further comprising:
transmitting, by the system, an electronic contract document relating to the highest-rated approved financial offer to the communication device associated with the consumer identity as part of the presenting of the highest-rated approved financial offer to the communication device or in response to the receiving of the acceptance indicator.

24. The method of claim 23, further comprising:
evaluating, by the system, a signed electronic contract document, wherein the signed electronic contract document is the electronic contract document that has been electronically signed by the consumer identity; and
determining, by the system, whether an electronic signature of the consumer identity associated with the signed electronic contract document is verified based at least in part on the electronic signature of the consumer identity and an authentication credential associated with the electronic signature.

25. The method of claim 24, further comprising:
facilitating, by the system, executing a financial transaction associated with the highest-rated approved financial offer in response to determining that the electronic signature of the consumer identity is verified.

26. A computer-readable storage medium storing computer-executable instructions that, in response to execution, cause a system comprising a processor to perform operations, comprising:
evaluating a set of approved financial offers received from one or more devices associated with a set of financial service provider identities in relation to a consumer identity; and
determining a preferred approved financial offer from the set of approved financial offers, based at least in part on results of the evaluating of the set of approved financial offers and a financial offer criterion defined with respect to a current financial health score pre-associated with the consumer identity, for presentation to a communication device associated with the consumer identity, wherein the preferred approved financial offer has a highest financial offer score relative to financial offer scores of other approved financial offers in the set of approved financial offers, and the current financial health score is a financial health score that is updated by the system in an always-on operating environment.

27. The computer-readable storage medium of claim 26, wherein the operations further comprise:
receiving respective financial-related information associated with respective consumer identities, including the consumer identity, of the set of consumer identities;
analyzing the respective financial-related information;
generating a set of financial-related parameters associated with the set of consumer identities, wherein respective financial-related parameters of the set of financial-related parameters have respective parameter values in relation to the respective consumer identities based at least in part on results of the analyzing of the respective financial-related information associated with the respective consumer identities; and
presenting the set of financial-related parameters associated with the set of consumer identities to respective financial service provider (FSP) credit management components associated with respective financial service provider identities of the set of financial service provider identities to facilitate generating approved financial offers for the set of approved financial offers.

28. The computer-readable storage medium of claim 27, wherein the operations further comprise:
determining respective financial health scores associated with the respective consumer identities based at least in part on results of the analyzing of the respective financial-related information associated with the respective consumer identities and a financial assessment criterion.
